(19) United States
(12) Patent Application Publication
(10) Pub. No.: US 2026/0289476 A1
(43) Pub. Date: Sep. 24, 2026

(54) SYSTEM

(71) Applicant: SoftBank Group Corp., Tokyo (JP)

(72) Inventor: Yuta AKIMOTO, Tokyo (JP)

(73) Assignee: SoftBank Group Corp., Tokyo (JP)

(21) Appl. No.: 19/568,806

(22) Filed: Mar. 17, 2026

(30) Foreign Application Priority Data
Mar. 19, 2025 (JP) 2025-045217

(51) Int. Cl. G06Q 10/0639; G09B 7/04; G10L 25/63

(52) U.S. Cl. CPC G06Q 10/06398; G09B 7/04; G10L 25/63

(57) ABSTRACT

A system includes a processor that is configured to collect, as a dataset, success and failure experiences of a large number of sales staff and train a generative artificial intelligence model based on the dataset, generate an artificial intelligence customer by using the trained generative artificial intelligence model, and receive, from a user, a prompt for instructing execution of a sales activity and collect feedback through an interaction between the user and the artificial intelligence customer.

### CROSS-REFERENCE TO RELATED APPLICATION

This application is based on and claims priority under 35 USC 119 from Japanese Patent Application No. 2025-045217 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional sales training systems and tools, including classroom training, static e-learning materials, and simple script-based simulations, are insufficient to capture and utilize the large volume of success and failure experiences accumulated by extensive sales forces. These conventional approaches generally (i) fail to systematically aggregate real-world sales interactions as structured datasets, (ii) cannot continuously learn from such datasets to refine training content, and (iii) provide only limited or static customer simulations that do not adequately reflect realistic customer reactions or up-to-date sales trends. As a result, it is difficult for sales personnel to efficiently acquire and improve practical sales skills, and it is also difficult for organizations to convert collective sales know-how into a scalable and adaptive training environment.

In addition, existing artificial intelligence-based training systems often do not close the loop between user interactions and model improvement. In many cases, interactions between a user and an AI-driven training agent are not fed back as training data to update the underlying models, leading to stagnation in model performance and an inability to reflect new sales scenarios or changing market conditions. Furthermore, in known systems, it is typically not possible to dynamically adjust the reaction patterns of an artificial intelligence customer in real time according to user prompts or training objectives, which limits the customization and pedagogical effectiveness of the training scenarios.

Accordingly, there is a need for a system capable of (i) collecting, as a dataset, a large number of success and failure experiences from sales forces, (ii) training a generative artificial intelligence model using such a dataset to generate artificial intelligence customers, (iii) collecting feedback through interactions between users and the artificial intelligence customers, (iv) feeding back the interaction results as training data to improve model accuracy, and (v) dynamically adjusting reaction patterns of the artificial intelligence customers in response to user prompts, thereby realizing more realistic, adaptive, and effective sales training.

### SUMMARY

In order to solve the above-described problems, a system according to one aspect of the present invention comprises a processor, wherein the processor is configured to collect, as a dataset, success and failure experiences of a large number of sales staff and train a generative artificial intelligence model based on the dataset. The processor is further configured to generate an artificial intelligence customer by using the trained generative artificial intelligence model, and to receive, from a user, a prompt for instructing execution of a sales activity and collect feedback through an interaction between the user and the artificial intelligence customer. By doing so, the system converts large-scale historical sales experiences into a machine-learned generative model that can simulate realistic customer behaviors and provide interactive training sessions for users.

In addition, in the system according to another aspect, the processor is configured to feed back a result of the sales activity performed with respect to the artificial intelligence customer as training data for the generative artificial intelligence model, and to improve accuracy of the generative artificial intelligence model based on the training data. Thus, the system forms a feedback loop in which interactions between users and artificial intelligence customers are continuously accumulated and utilized to refine the generative artificial intelligence model, enabling the artificial intelligence customers to reflect the latest sales patterns, objections, and effective responses.

Furthermore, in the system according to still another aspect, the processor is configured to dynamically adjust a reaction pattern of the artificial intelligence customer generated based on a learning result of the generative artificial intelligence model, in response to the prompt from the user. This enables the artificial intelligence customer to change, in real time, its behavior and response style according to user input, scenario configuration, or training objectives, thereby providing a flexible and customizable training environment. By combining these configurations, the present invention enables efficient utilization of collective sales knowledge, continuous improvement of the generative artificial intelligence model, and provision of adaptive and realistic sales training through artificial intelligence customers.

The term “system” refers to an arrangement including at least one hardware device and associated software components that collectively execute the processing described in the claims.

The term “processor” refers to one or more hardware processing units, such as a central processing unit (CPU), graphics processing unit (GPU), application-specific integrated circuit (ASIC), or other computation-capable circuitry, configured to execute instructions to perform the claimed functions.

The term “success and failure experiences” refers to records of sales activities that include information indicating whether each sales activity resulted in a successful outcome, such as a contract or order, or an unsuccessful outcome, such as loss of a deal.

The term “sales staff” refers to human personnel engaged in sales activities, including, for example, sales representatives, account managers, or other employees responsible for proposing products or services to customers.

The term “dataset” refers to a structured or semi-structured collection of data items, including at least sales interaction records and corresponding outcomes, that is suitable for input to a machine learning process.

The term “generative artificial intelligence model” refers to a machine learning model configured to generate new data instances, such as text, dialogue, or behavioral patterns, based on patterns learned from training data.

The term “train a generative artificial intelligence model” refers to a process in which the processor adjusts parameters of the generative artificial intelligence model using the dataset so that the model learns statistical or semantic patterns present in the dataset.

The term “artificial intelligence customer” refers to a virtual entity implemented by software and driven by the generative artificial intelligence model, the virtual entity being configured to simulate behaviors, responses, and dialogue of a customer in a sales context.

The term “prompt” refers to an input provided by a user, including natural language text or structured commands, for instructing the system to cause the artificial intelligence customer to perform or respond to a sales activity.

The term “sales activity” refers to an action or series of actions carried out in a sales context, including proposing a product or service, handling objections, negotiating terms, or attempting to close a deal.

The term “interaction” refers to a sequence of exchanges between the user and the artificial intelligence customer, including user inputs and artificial intelligence customer outputs, typically in the form of dialogue.

The term “feedback” refers to information derived from the interaction, including conversation content, user actions, and outcomes, used to evaluate, adjust, or retrain the generative artificial intelligence model or associated behaviors.

The term “result of the sales activity” refers to an outcome associated with an interaction between the user and the artificial intelligence customer, including, for example, whether a simulated deal is concluded successfully or unsuccessfully.

The term “training data” refers to data used by the processor to train or update the generative artificial intelligence model, the data including at least the result of the sales activity and associated interaction information.

The term “accuracy of the generative artificial intelligence model” refers to the degree to which outputs of the generative artificial intelligence model, such as generated responses or behaviors, correctly reflect or predict desired properties, patterns, or outcomes according to predetermined evaluation criteria.

The term “reaction pattern” refers to a set of rules, parameters, or learned behaviors that determine how the artificial intelligence customer selects or generates its responses during an interaction.

The term “learning result of the generative artificial intelligence model” refers to information, such as model parameters or derived behavioral characteristics, that is obtained after training the generative artificial intelligence model on the dataset.

The term “dynamically adjust” refers to modifying, during operation and in real time or near real time, parameters or behaviors of the artificial intelligence customer without requiring recompilation or redeployment of the entire system.

The term “in response to the prompt from the user” refers to causing a change or action, such as adjustment of the reaction pattern of the artificial intelligence customer, based on content, type, or context of input provided by the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

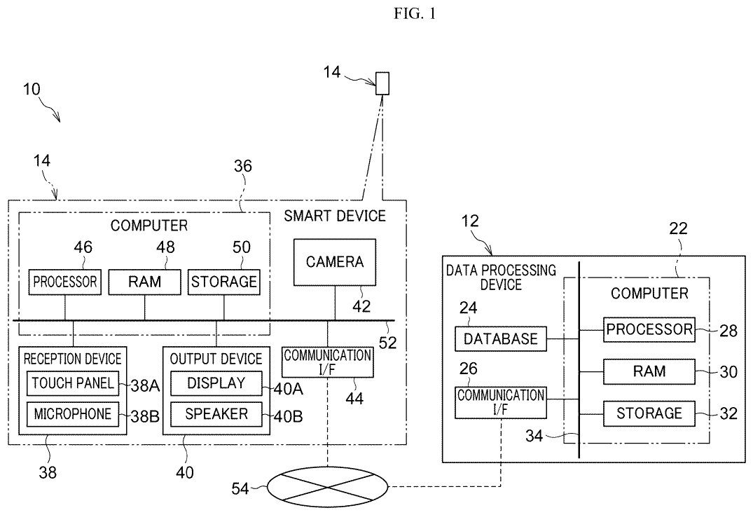

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

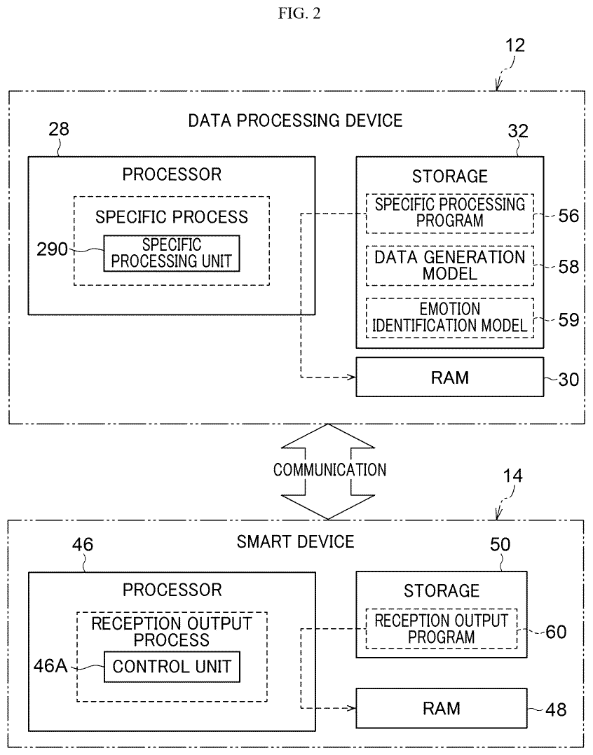

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented training systems for sales activities typically rely on static rule-based scripts or manually authored scenarios that do not adapt to the individual user or to evolving real-world sales patterns. Such systems use fixed dialogue trees and simple scoring rules, resulting in limited variability, low realism, and poor alignment with the actual behaviors of customers observed in operational environments. From the perspective of computer technology, these systems do not effectively utilize accumulated interaction logs as machine-readable data for improving core components such as prediction models and dialogue generation modules. As a result, the processing units of such systems fail to exploit available computing resources and machine learning techniques to provide higher-quality decision support and interaction control.

Furthermore, known systems generally separate prediction processing and dialogue generation processing. A prediction model, if used at all, is often only invoked in an offline analytics pipeline, while a dialogue engine uses pre-authored templates without dynamically leveraging the prediction model's output. This architectural separation leads to inefficient data flow, redundant storage of similar data structures, and underutilization of the available models. The system therefore cannot dynamically adjust virtual customer behavior or difficulty in response to user skill, historical performance, and current interaction context, which limits the effectiveness of simulation as a training tool.

In addition, existing generative artificial intelligence models, when used directly as conversational agents, are typically driven by ad hoc prompt sentences that are manually constructed by human operators. Such prompts do not systematically encode structured success patterns extracted from large-scale historical datasets, and thus the generative models operate without a robust, data-driven grounding. This causes instability in generated responses, inconsistent scenario quality, and difficulty in controlling the complexity and evaluation criteria of a session. From a system viewpoint, there is no closed feedback loop by which the outputs of the generative model and the user's responses are consistently captured, evaluated, and reused for continuous improvement of the underlying models.

Moreover, many systems do not support real-time, model-based evaluation of user utterances at a fine-grained level. Feedback is often provided only as coarse, manually defined ratings after the completion of a session. As a consequence, the processor does not efficiently transform incoming textual or audio interaction streams into structured feature data, does not apply learned prediction models at low latency, and does not provide immediate, context-aware feedback that can guide the user's next actions. This results in suboptimal utilization of computing resources for online inference and feature extraction, and reduces the technical effectiveness of the system in assisting user decision-making during interaction.

Additionally, even when logs are stored, they are commonly archived as unstructured text or simple records that are not integrated back into the model training pipeline. This breaks the feedback loop between runtime behavior and model refinement. The underlying computational architecture therefore does not achieve continuous learning: it lacks automated mechanisms to transform interaction histories and evaluation indices into additional training data, retrain or fine-tune prediction and generative models, and redeploy improved models in a systematic manner.

Accordingly, there is a need for an improved computer-implemented system that: (i) integrates preprocessing of historical sales data, predictive modeling, and generative dialogue modeling into a single pipeline; (ii) automatically constructs structured prompt sentences for a generative artificial intelligence model based on prediction model outputs and historical success patterns; (iii) executes real-time evaluation of user utterances using a trained prediction model to generate granular feedback indices; and (iv) accumulates dialogue history and evaluation information as additional learning data to continuously retrain or fine-tune both prediction and generative models. Such a system would improve the technical functioning of the computer itself by optimizing data flow, model interaction, and online inference processing, thereby yielding more accurate, adaptive, and efficient generation and control of artificial intelligence customer scenarios.

The specific processing by the specific processing unit 290 of the data processing device 12 in Example 1 is realized by the following means.

The present invention provides a server comprising a processor and an information storage device, the processor being configured to execute machine-readable instructions to acquire, from the information storage device, historical information relating to business activities, to perform data preprocessing including completion of missing values, removal of abnormal values, and encoding of categorical values to generate numerical feature information, to construct and train a prediction machine learning model on the basis of the numerical feature information and outcome information so as to obtain a trained prediction model, to extract sales patterns and customer segments having a relatively high probability of success by using output results of the trained prediction model and the historical information, to generate structured prompt sentences including virtual customer conditions and dialogue structures on the basis of the extracted patterns and segments, to provide the structured prompt sentences as input to a generative artificial intelligence model so as to generate artificial intelligence customer scenario information including virtual customer persona information, initial utterance information, objection information, and a plurality of response path information items, to generate and control a dialogue simulation environment using the artificial intelligence customer scenario information while exchanging utterance information and response information with a user terminal, to record dialogue history information including user responses and artificial intelligence customer utterances during the dialogue simulation, to extract feature quantities from the dialogue history information, to evaluate the user responses in real time or near real time by applying the trained prediction model to the extracted feature quantities so as to generate feedback information including evaluation indices such as objection handling degree, value presentation degree, and presence or absence of closing behavior, to output the feedback information to the user terminal, and to accumulate the dialogue history information and the evaluation indices as additional learning data and retrain or fine-tune at least one of the prediction machine learning model and the generative artificial intelligence model. This enables integration of predictive modeling, generative scenario synthesis, and online evaluation into a single closed-loop computational architecture, thereby improving computer-implemented processing for generating adaptive artificial intelligence customer scenarios, optimizing data flows for model interaction, and enhancing the accuracy, stability, and responsiveness of model-based feedback during business activity simulations.

The term “historical information” refers to machine-readable data records representing past business activities, including at least customer attributes, sales methods, interaction logs, and associated outcomes such as success or failure.

The term “information storage device” refers to any computer-readable storage medium, such as a magnetic storage device, an optical storage device, a semiconductor memory device, or a network-accessible storage system, that is configured to store data for access by a processor.

The term “customer attribute information” refers to data fields that describe characteristics of a customer entity, including but not limited to industry classification, organization size, decision-maker role, geographical region, and budget-related indicators.

The term “sales method information” refers to data fields that describe how a business activity was conducted, including communication channels, presentation styles, pricing approaches, negotiation strategies, and sequences of actions taken by a sales representative.

The term “outcome information” refers to data that indicates a result of a business activity, including but not limited to success, partial success, failure, probability of closing, revenue amount, or other performance metrics associated with the activity.

The term “preprocessing” refers to computational operations performed on raw historical information to convert it into a form suitable for machine learning, including at least completion of missing values, removal or correction of abnormal values, normalization or scaling of numerical values, and encoding of categorical values.

The term “numerical feature information” refers to a set of numerical values derived from processed historical information, arranged as feature vectors or matrices, which are suitable for input to a machine learning model.

The term “prediction machine learning model” refers to a parameterized computational model, such as a neural network, decision tree model, or ensemble model, that is trained on numerical feature information and outcome information to output prediction information indicative of a probability or classification of success or failure of a business activity.

The term “trained prediction model” refers to a prediction machine learning model whose parameters have been optimized by a training process using historical data so that the model is configured to output prediction information for new input data.

The term “prediction information” refers to output data generated by a trained prediction model, including at least a probability value, score, or classification label indicating a likelihood of success or failure of a business activity.

The term “sales patterns” refers to combinations of features, such as sequences of actions, talk structures, and offer configurations, identified in historical information as being associated with particular levels of business outcome performance.

The term “customer segments” refers to groupings of customers categorized according to one or more customer attributes, such as industry, organization size, or decision-maker profile, which are used for targeted analysis and scenario generation.

The term “prompt sentence” refers to a structured text string or sequence of tokens that encodes constraints, instructions, and context conditions, including virtual customer conditions and dialogue structures, and that is provided as input to a generative artificial intelligence model to control generated output.

The term “virtual customer conditions” refers to parameterized constraints describing a simulated customer, including at least persona traits, interest levels, typical objections, and scenario objectives, which are embedded in a prompt sentence.

The term “dialogue structure” refers to a representation of an expected or possible sequence of conversational turns, including initial utterances, branching points, and response paths, used to guide generation and control of a dialogue scenario.

The term “generative artificial intelligence model” refers to a machine learning model, such as a generative language model, that is configured to generate sequences of content, including natural language text, in response to input data such as prompt sentences.

The term “artificial intelligence customer scenario information” refers to structured data generated by a generative artificial intelligence model, including at least virtual customer persona information, initial utterance information, objection information, and response path information, which together define a simulated conversational situation.

The term “persona information” refers to descriptive data about a virtual customer's profile, including roles, goals, preferences, constraints, and behavioral tendencies, which are used to condition dialogue generation.

The term “initial utterance information” refers to text or structured data that defines one or more first messages spoken or displayed by a virtual customer at the beginning of a dialogue simulation.

The term “objection information” refers to data representing typical concerns, refusals, or negative reactions expressed by a virtual customer, including their content, timing, and conditions of occurrence during a dialogue.

The term “response path information” refers to data representing alternative conversational branches that a virtual customer may follow, each branch being conditioned on user responses or internal scenario parameters.

The term “dialogue simulation environment” refers to a computational environment that controls and manages a sequence of interactions between a user and an artificial intelligence customer, including state management, message exchange, and timing.

The term “user information processing terminal” refers to an electronic device operated by a user, such as a desktop computer, a notebook computer, a tablet device, a smartphone, or a dedicated terminal, that is configured to send and receive data to and from a server.

The term “utterance information” refers to data representing a message in a dialogue, including text data or data derived from audio input, that corresponds to a single conversational turn by a virtual customer or a user.

The term “response information” refers to utterance information generated by a user in reply to utterance information from an artificial intelligence customer within the dialogue simulation environment.

The term “dialogue history information” refers to a record of multiple utterance information items exchanged between a user and an artificial intelligence customer over time, including timestamps, speaker identifiers, and session identifiers.

The term “feature quantities” refers to numerical or symbolic values extracted from dialogue history information, including linguistic, semantic, or interactional characteristics that can be used as input to a prediction model.

The term “feedback information” refers to data generated by the system that evaluates user responses according to one or more evaluation indices and provides guidance, comments, or scores for improving user performance.

The term “evaluation indices” refers to quantitative or qualitative measures used to assess aspects of user responses, including but not limited to objection handling degree, value presentation degree, and presence or absence of closing behavior.

The term “objection handling degree” refers to an evaluation index indicating how effectively a user addresses, mitigates, or resolves objections expressed by a virtual customer.

The term “value presentation degree” refers to an evaluation index indicating how clearly and persuasively a user describes benefits, advantages, or value propositions of an offered product or service.

The term “presence or absence of closing behavior” refers to an evaluation index indicating whether, and to what extent, a user attempts to secure a commitment or next step from a virtual customer.

The term “skill level information” refers to data representing an estimated or declared proficiency level of a user, which may be derived from past performance metrics, user profiles, or explicit configuration.

The term “training objective information” refers to data identifying one or more goals of a training session, such as practicing objection handling, improving closing techniques, or refining value communication.

The term “additional learning data” refers to data derived from runtime operation of the system, including dialogue history information and associated evaluation indices, that is stored for use in retraining or fine-tuning machine learning models.

The term “retrain” refers to a process in which a machine learning model is trained again using a dataset that includes new data, with model parameters updated from an initial state or from previously learned parameters.

The term “fine-tune” refers to a process in which an already trained machine learning model is further trained using additional data, typically with a smaller learning rate or limited parameter updates, to adapt the model to a specific domain or task.

In one embodiment, a server, a plurality of terminals, and a communication network together implement a system that executes the claimed functions by using specific hardware and software components. The server includes at least one processor, a main memory, a non-volatile storage device such as a solid-state drive, and a network interface. The server executes an operating system such as a general-purpose server operating system, and runs middleware including a web application framework, a database management system, and machine learning libraries. The terminal includes a processor, a display device, an input device such as a keyboard, pointing device, or microphone, a memory, and a network interface, and executes a client program such as a web browser or a native application.

The server stores, in the non-volatile storage device, historical information related to business activities. The historical information is stored in at least one relational database table or structured file format. The server uses a database management system, for example a relational database engine, to manage records that include customer attribute information, sales method information, and outcome information. The server accesses the database through a data access library executed by the processor. By structuring the historical information in normalized tables and indexed fields, the server enables efficient retrieval and update of large-scale datasets without excessive memory usage or latency.

The server executes a data preprocessing module implemented, for example, in a programming language runtime combined with a data analysis library such as a tabular data processing library and a numerical computation library. The server loads batches of historical information records into main memory as tabular data structures. The server scans each column to identify missing values by checking for null markers or sentinel values and computes replacement values such as medians or most frequent categories. The server writes these replacement values back into the tabular data structure. The server computes statistical measures such as means and standard deviations for numerical columns and calculates standardized scores to detect abnormal values. The server removes or clips rows or values that exceed a defined threshold. The server performs encoding for categorical attributes by generating a plurality of binary indicator columns for each category or by assigning integer indices for use with embedding layers. The server may normalize numerical features by subtracting means and dividing by standard deviations, and may store normalization parameters in configuration files. By converting heterogeneous raw records into dense numerical feature matrices and associated label vectors, the server improves caching locality and parallelization for subsequent machine learning computation, thereby reducing training time and memory fragmentation compared to ad hoc, on-the-fly encoding.

The server constructs a prediction machine learning model by using a machine learning framework such as a tensor computation library or a neural network training framework. In one embodiment, the server defines a feedforward neural network having an input layer whose dimensionality corresponds to the number of numerical feature values, one or more hidden layers with nonlinear activation functions such as rectified linear units, and an output layer with a sigmoid activation that produces a probability value representing a likelihood of success of a business activity. The server configures the model with parameters including the number of hidden units, the number of layers, learning rate, batch size, and regularization coefficients.

The server trains the prediction model by repeatedly executing forward propagation and backpropagation on mini-batches of the numerical feature information. The server computes a loss value such as binary cross-entropy between predicted probabilities and actual outcome labels, and computes gradients of the loss with respect to network weights using automatic differentiation provided by the machine learning framework. The server updates the weights using an optimization algorithm such as stochastic gradient descent, an adaptive gradient method, or a momentum-based method. The server evaluates the trained model on a validation dataset, computes performance measures such as accuracy, precision, recall, and area under a receiver operating characteristic curve, and stores model checkpoints and performance metrics in the storage device.

The server improves computer technology by implementing a training pipeline that dynamically adjusts hyperparameters according to validation performance without human intervention. For example, the server reduces the learning rate or modifies the network depth based on plateau detection in validation loss. This automatic adjustment reduces the number of training epochs and prevents overfitting, thereby improving computational efficiency and predictive accuracy compared to fixed hyperparameter configurations.

The server, after obtaining the trained prediction model, performs pattern extraction on the historical information. The server groups records by customer segment attributes and computes aggregated statistics of predicted success probabilities. The server identifies combinations of customer attributes and sales methods whose predicted success probability exceeds a threshold, and stores these combinations as sales patterns. The server may represent each sales pattern as a template structure containing customer segment descriptors, sequence identifiers for interaction stages, and key feature indicators such as presence of certain objection types or discount policies.

The server then generates a prompt sentence for a generative AI model by combining pattern information with a dialogue structure template. The server uses a prompt construction program that populates variable slots in a base template with text tokens representing the selected customer segment, common objections, and successful conversational moves. For example, the server may generate a prompt sentence such as:
“Based on high-success sales patterns for small enterprises in the technology sector interested in subscription-based services, generate a virtual customer persona and a multi-step conversation script. The virtual customer should express concerns about budget and deployment time, and respond differently depending on how clearly the sales representative explains value and implementation support.”

The server further generates another type of prompt sentence that includes conversation history. For example, during an ongoing session, the server may construct the following prompt sentence:
“You are a virtual customer: a small business owner who is interested in a new cloud service but is concerned about cost and data migration. The following is the conversation so far: [conversation history]. Based on your persona and the history, generate your next reply. Do not reveal internal evaluation criteria, but adjust your attitude from skeptical to interested if the last answer addressed both cost and migration concerns with concrete details.”

The server supplies the generated prompt sentence to a generative AI model that is configured as a large-scale language model. In one embodiment, the generative AI model is implemented as a transformer-based neural network with multiple attention layers, trained on sequence data to predict next tokens given prior context. The server accesses the generative AI model either locally, by loading model weights into memory and executing inference on a graphics processing unit, or remotely, through an application programming interface provided by an external inference service. The server sets control parameters such as temperature, maximum token length, and top-k or nucleus sampling parameters to regulate randomness, length, and diversity of the generated text.

The server executes inference of the generative AI model by providing the prompt sentence as an input token sequence. The generative AI model computes attention weights across tokens and generates, for each decoding step, a probability distribution over a vocabulary.

The server selects tokens according to the sampling strategy and appends them to the output sequence until a termination condition is met. The server then parses the generated sequence into components such as persona description text, initial customer utterance, lists of objection statements, and descriptions of possible reactions. The server converts the generated components into a structured scenario record, for example containing fields for persona information, initial utterance information, objection information, and response path information. By structuring the generative output, the server reduces ambiguity in subsequent processing and allows deterministic control of conversation branching, which is a technical improvement over ad hoc textual responses.

The server stores the artificial intelligence customer scenario information in a scenario database together with metadata such as difficulty level, target product category, and training objective tags. The server assigns identifiers to each scenario and creates indices for efficient retrieval based on user preferences and training objectives.

The server exposes a network interface that allows the terminal to request scenario lists and initiate dialogue simulations. The server uses a web application framework to handle requests, authenticate users, and manage session state. The server transmits, in response to a scenario selection, an initial message and persona summary to the terminal, along with session identifiers. The server maintains, in memory or in a session store, a dialogue state object that records the sequence of utterances, internal flags indicating which objections have been raised, and current difficulty settings.

The terminal displays the received persona information and initial utterance on a graphical user interface. The terminal may use a markup rendering engine to present the information in a chat-style layout. The user reads the display and input a response using a text input field or speech input. When the user uses speech input, the terminal captures an audio stream from a microphone, segments the audio according to silence detection, and executes a speech-to-text engine to transform the audio into a sequence of text tokens. The terminal may use a local speech recognition library or an external speech recognition service. The terminal then packages either the raw text typed by the user or the recognized text, together with the session identifier and local timestamps, into a message that is sent to the server over the network using a secure communication protocol.

The server receives user response information and appends it to the dialogue history information associated with the session. The server executes a text feature extraction module that converts each user utterance into feature quantities. The server may tokenize the text, remove stop words, and compute term frequency inverse document frequency values, or may obtain dense vector representations using a separate sentence embedding model. The server may additionally derive binary features indicating whether a numerical value, time frame, or explicit closing phrase is present. The server aggregates these features with context features such as dialogue turn index or scenario difficulty flag.

The server applies the trained prediction model to the extracted feature quantities in real time. For example, the server creates an input vector that combines user utterance features and scenario features, and triggers inference in the trained prediction model. The server obtains a prediction score that estimates the likelihood that the user's current response contributes to a successful outcome if the dialogue continues. The server then computes evaluation indices such as objection handling degree by mapping the presence of objection-related tokens and their alignment with known successful patterns. The server computes value presentation degree by identifying whether key benefit terms were included and whether quantified benefits or comparisons were presented. The server detects presence or absence of closing behavior by searching for explicit request phrases or commitment proposals. The server combines these indicators with the prediction score into a structured feedback information object.

The server transmits the feedback information to the terminal immediately after each user utterance or at specified intervals. The terminal decodes the feedback information and updates visual indicators such as colored bars representing evaluation indices, short text tips adjacent to the latest utterance, or summary badges indicating whether the last reply improved or degraded the predicted success probability. The terminal may also play audio alerts or vibrating feedback to emphasize critical suggestions. By generating and transferring evaluation results at low latency, the server enables the user to adapt behavior in the next turn without leaving the ongoing simulation, which is a technical improvement in interactive training systems.

The user observes the feedback on the terminal and modifies subsequent responses. Over multiple sessions, the user may adjust strategy and language according to the patterns highlighted by the system. The user does not manually compute or interpret large sets of historical statistics; instead, the server applies trained models to interpret and aggregate relevant information. This division of tasks yields a technical effect: the processor can process continuous streams of user interaction data and generate context-aware feedback at a speed and scale that is infeasible for a human operator, while maintaining consistent evaluation criteria across sessions.

The server also accumulates dialogue history information and associated evaluation indices as additional learning data. After a predetermined amount of new interaction data has been stored, the server executes a batch process that reloads the logs from the storage device, filters out incomplete sessions, and re-preprocesses the data into feature vectors and labels for further training. The server may treat high-scoring user utterances as positive examples for certain behaviors and low-scoring utterances as negative examples. The server retrains or fine-tunes the prediction model by adding these examples to the training set, thereby updating the mapping between feature patterns and predicted success probabilities.

The server may also update parameters of the generative AI model or adjust the prompt construction rules. For example, the server may identify frequently successful reply patterns and add them as explicit instructions to future prompt sentences, such as:
“When the sales representative clearly quantifies cost savings and implementation time, the virtual customer should gradually reduce objections and ask for next steps.”

By integrating runtime behavior into the model training cycle, the server creates a closed-loop architecture in which the generative AI model and prediction model co-evolve. This improves the alignment between generated scenario behavior and actual observed user performance, enabling more realistic and technically accurate simulations.

The system architecture improves computer technology in several ways. First, the data preprocessing and feature encoding steps reduce input dimensionality and sparsity, enabling more efficient neural network computation with fewer memory accesses and cache misses. Second, the integration of prediction and generation modules through structured prompt sentences reduces redundant data conversions and ensures that both models share a consistent representation of customer segments and sales patterns. Third, the server's design for real-time inference and feedback ensures that model evaluation is performed within strict latency constraints, improving responsiveness and enabling interactive use cases that conventional offline analytics cannot support. Fourth, the closed-loop learning mechanism reduces manual model tuning by automatically exploiting accumulated interaction data, thereby decreasing the need for human labeling and analysis.

AI processing in this system is not a mere automation of human judgment. The server applies non-intuitive parameter optimization procedures, high-dimensional feature embeddings, and attention-based sequence modeling to process data in ways that are not feasible by human reasoning. The server, by combining prediction scores and structural pattern extraction, enforces rules such as dynamic difficulty adjustment and objection scheduling that are derived from training data rather than predefined business rules. These machine-learned rules and their computational execution pathways provide a technical improvement in the control of the dialogue simulation environment, including more stable convergence of conversation outcomes, lower variance in evaluation accuracy, and more efficient utilization of network bandwidth by compressing complex scenario logic into model parameters instead of explicit rule sets.

Alternative embodiments may use different architectures while preserving the described technical advantages. In one variation, the prediction machine learning model may be a gradient-boosted decision tree ensemble instead of a neural network, which can improve interpretability and training speed for certain datasets. In another variation, the generative AI model may be a smaller transformer model deployed entirely on-premises for environments with strict privacy requirements. The server may also employ different feature extraction methods, such as convolutional networks over token sequences or graph-based encodings of dialogue state. The terminal may be implemented as a native application that caches scenario information locally for reduced latency, synchronizing only user responses and essential feedback with the server to reduce communication load.

In all such embodiments, the server, the terminal, and the user cooperate through clearly defined data structures and processing modules to realize an integrated system for business activity simulation. The system achieves not only an improvement in the quality of training content but also an improvement in the technical field of computer-implemented interactive systems, by optimizing data flow, model utilization, and real-time inference for generative AI models and prediction models based on structured prompt sentences.

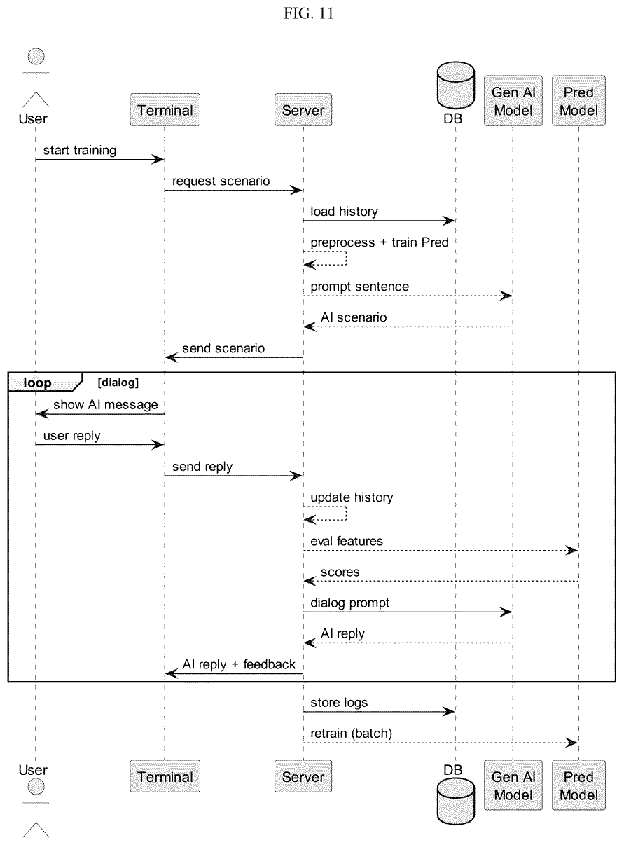

The following describes the processing flow using FIG. 11.

### Step 1:

Server acquires historical information related to business activities from an information storage device.

Server receives, as input, record sets containing at least customer attribute fields, sales method fields, and outcome fields.

Server issues structured queries to a database engine and loads the query results into main memory as tabular data.

Server outputs an in-memory dataset composed of multiple records, each record including normalized columns representing the retrieved fields.

### Step 2:

Server preprocesses the historical information to generate numerical feature information.

Server receives, as input, the in-memory dataset from Step 1.

Server scans each column to detect missing values, computes representative values such as medians or modes, and replaces missing entries accordingly.

Server calculates statistical measures for numeric columns, detects outliers using thresholds such as z-scores, and removes or clips abnormal entries.

Server converts categorical fields into numerical encodings by generating binary indicator columns or assigning integer identifiers.

Server normalizes or standardizes numeric columns using stored scaling parameters.

Server outputs a numerical feature matrix and an associated label vector corresponding to outcome information.

### Step 3:

Server trains a prediction machine learning model using the numerical feature information.

Server receives, as input, the numerical feature matrix and label vector from Step 2.

Server partitions the input data into training and validation subsets based on a predefined ratio.

Server initializes a model structure, for example a feedforward neural network with specified layer sizes and activation functions.

Server repeatedly performs forward propagation to compute predicted outputs, evaluates a loss function such as binary cross-entropy, and executes backpropagation to compute gradients.

Server updates model parameters using an optimization algorithm with a selected learning rate and batch size.

Server evaluates validation performance after each epoch and stores the model state achieving the best validation metric.

Server outputs a trained prediction model and validation metrics.

### Step 4:

Server extracts sales patterns and customer segments using the trained prediction model.

Server receives, as input, the trained prediction model from Step 3 and the preprocessed numerical feature matrix and associated attribute metadata from Step 2.

Server groups data records by selected customer attributes such as industry or organization size and computes average predicted success probabilities per group by applying the trained prediction model.

Server identifies groups and feature combinations whose predicted success probabilities exceed predetermined thresholds.

Server encodes each identified group and feature combination into a structured pattern record containing customer segment descriptors and indicative feature flags.

Server outputs a collection of sales pattern records and associated customer segment definitions.

### Step 5:

Server generates a prompt sentence for a generative AI model based on the extracted patterns.

Server receives, as input, the sales pattern records from Step 4 and a dialogue structure template stored in configuration data.

Server selects one or more pattern records according to a requested training objective, such as objection handling or closing behavior training.

Server fills slots in the dialogue structure template with text fragments derived from the selected patterns, including customer segment descriptions, typical objections, and successful response strategies.

Server concatenates the filled template into a textual prompt sentence.

For example, server may generate:
“Using past sales data, learn the sales techniques with the highest success rate and generate a virtual customer. Create a detailed role-playing scenario in which a sales representative proposes a new product to the generated virtual customer. Include the customer's background, typical questions, common objections, and several possible reaction paths depending on the representative's responses.”

Server outputs the constructed prompt sentence ready to be provided to the generative AI model.

### Step 6:

Server generates artificial intelligence customer scenario information using the generative AI model.

Server receives, as input, the prompt sentence from Step 5.

Server tokenizes the prompt sentence and sends the token sequence to the generative AI model with decoding parameters such as temperature and maximum token length.

Server triggers inference in the generative AI model, which computes attention-based transformations over the input tokens and iteratively generates output tokens according to a sampling strategy.

Server reconstructs the output tokens into a text sequence and parses the sequence into structured components including persona description, initial customer utterance, objection list, and alternative response paths.

Server encapsulates these components into a scenario record including persona information, initial utterance information, objection information, and response path information.

Server outputs the artificial intelligence customer scenario information and stores it in a scenario repository.

### Step 7:

Server provides the scenario to the terminal and initializes a dialogue simulation session.

Server receives, as input, a scenario selection request and user identifier from the terminal.

Server retrieves the corresponding scenario record generated in Step 6 from the scenario repository.

Server creates a session object containing scenario identifiers, initial conversation state, and control parameters such as difficulty level.

Server sends, as output, persona summary data and the initial virtual customer utterance to the terminal together with a session identifier.

### Step 8:

Terminal presents the scenario information to the user and collects a user response.

Terminal receives, as input, the persona summary, initial utterance, and session identifier from the server.

Terminal renders the persona summary and initial utterance on a display in a conversation-style interface.

User reads the displayed information and enters a response using a text input control or speaks into a microphone.

If the user uses speech, terminal records audio, segments the audio stream, executes speech recognition to convert audio into text, and normalizes the recognized text.

Terminal packages the user's text response along with the session identifier and local timestamp.

Terminal outputs a message containing the user response information to the server.

### Step 9:

Server updates dialogue history and constructs a new prompt sentence for the generative AI model.

Server receives, as input, the user response message from the terminal.

Server appends the user response and the last virtual customer utterance to a dialogue history structure associated with the session identifier.

Server formats the dialogue history into a textual summary including speaker labels and turn order.

Server combines the persona description from the scenario record with the dialogue history and control instructions to create a new prompt sentence.

For example, server may generate:
“You are a virtual customer who is a cost-sensitive small business owner considering a new cloud storage service. The following is the conversation so far: [dialogue history]. Based on your persona, generate your next reply. If the last answer clearly addressed cost, data security, and migration effort, reduce your objections and ask about contract details.”

Server outputs this updated prompt sentence for use by the generative AI model.

### Step 10:

Server generates the next artificial intelligence customer utterance using the generative AI model.

Server receives, as input, the updated prompt sentence from Step 9.

Server encodes the prompt sentence into tokens and performs inference using the generative AI model with predefined decoding parameters.

Server obtains an output token sequence that represents the next virtual customer utterance.

Server reconstructs the tokens into a text message, optionally trims or sanitizes content according to safety rules, and associates the message with the current dialogue state.

Server appends the virtual customer utterance to the dialogue history structure.

Server outputs the next artificial intelligence customer utterance to the terminal.

### Step 11:

Terminal displays the artificial intelligence customer utterance and continues the interaction cycle.

Terminal receives, as input, the next artificial intelligence customer utterance from the server. Terminal injects the utterance into the conversation interface as a new message from the virtual customer.

User reads the new utterance and prepares a subsequent response.

Terminal again collects the next user response as in Step 8 and outputs it to the server, thereby repeating the interaction loop.

### Step 12:

Server extracts feature quantities from the dialogue history for evaluation.

Server receives, as input, the updated dialogue history including the latest user response.

Server isolates the most recent user utterance and optionally a window of preceding utterances.

Server applies a text processing pipeline that tokenizes the utterance, removes stop words, identifies domain-specific terms, and generates a representation such as a tf-idf vector or a sentence embedding.

Server computes additional binary or numeric indicators such as the presence of quantified benefits, explicit closing phrases, or direct responses to objections.

Server concatenates these features with scenario metadata such as difficulty level and objection types raised.

Server outputs a feature vector representing the current user response and its context.

### Step 13:

Server evaluates the user response using the trained prediction model and generates feedback information.

Server receives, as input, the feature vector from Step 12 and the trained prediction model from Step 3.

Server feeds the feature vector into the trained prediction model and performs an inference pass to obtain a predicted success probability or classification label.

Server interprets the model output and calculates evaluation indices including objection handling degree, value presentation degree, and presence or absence of closing behavior.

Server constructs a feedback record that includes numerical scores, categorical assessments (for example “strong,” “moderate,” or “weak”), and short textual guidance aligned with the evaluation indices.

Server links the feedback record to the corresponding turn in the dialogue history.

Server outputs the feedback information to the terminal.

### Step 14:

Terminal presents real-time feedback to the user.

Terminal receives, as input, the feedback information from the server.

Terminal maps numerical scores to visual indicators such as progress bars, colored icons, or badges, and displays these indicators in proximity to the corresponding user utterance in the conversation interface.

Terminal displays the textual guidance as short hints, for example “You mentioned benefits but did not quantify cost savings” or “You attempted a closing, consider specifying a concrete next step.”

User interprets the feedback and adjusts the next response accordingly.

Terminal outputs any user-initiated actions, such as requesting more detailed feedback or viewing aggregated scores, as additional messages to the server when invoked.

### Step 15:

Server logs dialogue history and feedback for later learning.

Server receives, as input, the complete or partial dialogue history and associated feedback records at predetermined intervals or at session termination.

Server aggregates the history and feedback records into a structured log entry containing user identifiers, scenario identifiers, turn-by-turn utterances, feature vectors, and evaluation indices.

Server writes these log entries to a persistent storage subsystem such as a log database or file-based store.

Server may also generate summary statistics for each session and store them in a separate summary table.

Server outputs confirmation of successful logging and marks the session as completed or archived.

### Step 16:

Server retrains or fine-tunes the prediction model and adjusts generative behavior using accumulated logs.

Server receives, as input, a collection of stored log entries from Step 15 when a retraining process is triggered.

Server extracts labeled examples from the logs, for example treating high-scoring utterances as positive samples for effective objection handling and low-scoring utterances as negative samples.

Server constructs updated training datasets by combining original training examples with the new samples, and re-executes preprocessing to ensure consistent feature scaling and encoding.

Server retrains the prediction model from an initial or previous parameter state using the updated training dataset, updating model weights via iterative optimization.

Server optionally modifies prompt construction rules by integrating frequently successful phrases or structures into base templates, thereby influencing future prompt sentences sent to the generative AI model.

Server outputs an updated trained prediction model and revised prompt templates, and deploys them for subsequent sessions so that new interactions benefit from refined evaluation and generation behavior.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented sales training systems typically rely on static scenarios and manually authored scripts that are stored in a content repository and sequentially presented to a user. These systems do not exploit large-scale historical interaction data in a structured manner, and therefore cannot adapt dialog flows or difficulty levels based on patterns actually correlated with successful sales outcomes. As a result, the generated training content often fails to approximate real customer behavior, and the trainee cannot reliably transfer skills learned in the virtual environment to real-world sales situations. Further, in existing systems, feedback to the user is usually based on simple rule sets or keyword matching, implemented as fixed program logic. Such approaches cannot fully utilize modern natural language processing capabilities, and tend to produce generic, low-granularity feedback that does not address the specific phrasing, structure, and persuasive strength of the user's utterance in context. This leads to inefficient use of computing resources, because the same processing power could, in principle, be used to generate higher quality, context-aware feedback by combining predictive modeling with generative artificial intelligence.

In addition, conventional systems do not tightly integrate predictive models trained on historical success/failure data with generative artificial intelligence models. Typically, a generative model is prompted with manually created instructions that are not grounded in a learned success pattern. Consequently, the dialog behavior of a virtual customer and the feedback content can diverge from those patterns that empirically lead to successful outcomes. The absence of a closed feedback loop between real or simulated interaction logs, predictive modeling, and prompt design for the generative model limits the ability of the system to improve over time.

Moreover, many existing systems treat the user interface layer, including wearable displays and audio interfaces, as a mere presentation medium without structuring the underlying dialog data in a way that facilitates fine-grained state tracking, branching, and logging.

Without machine-readable scenario structures and explicit branch transition information, the system cannot efficiently compute next dialog turns, nor can it systematically log interaction states for retraining models. This restricts the scalability and robustness of the training platform as a computer system.

Accordingly, there is a need for a computer-implemented system and method that (i) generates and updates a prediction model from large volumes of historical interaction data to estimate success probabilities, (ii) programmatically constructs prompt sentences for a generative artificial intelligence model based on features known to contribute to success, (iii) structures generated scenarios into machine-readable dialog units with explicit branching logic, (iv) evaluates a user's utterances using natural language processing in coordination with the prediction model, (v) generates detailed, context-aware feedback and next virtual customer utterances via the generative model, and (vi) closes the loop by continuously retraining and updating both the prediction model and prompt-generation rules based on accumulated interaction logs. By improving the way computing resources are organized and orchestrated across data acquisition, model training, prompt generation, dialog control, and feedback generation, such a system can improve the functioning of the underlying computer technology itself, beyond mere automation of human training procedures.

The specific processing by the specific processing unit 290 of the data processing device 12 in Application Example 1 is realized by the following means.

The present invention provides a server comprising a processor, a storage device, a terminal interface, and an interface to a generative artificial intelligence model, the processor being configured to acquire, from the storage device, historical information relating to a plurality of interactions including sales activities, to extract and normalize feature information using identification information indicating success or failure as an objective variable, and to execute statistical learning processing on the normalized feature information to generate a prediction model that estimates a probability of success for a given interaction condition; to analyze the prediction model to identify feature information that contributes to success, to automatically generate prompt sentences including conditions such as sales situations, customer attributes, and dialog difficulty levels based on the identified feature information, and to provide the prompt sentences as structured input to the generative artificial intelligence model so as to generate scenario information including dialog scenarios and response patterns of a virtual counterpart; to transform the generated scenario information into a machine-readable structure that associates, with each dialog turn, utterance information, assumed user-intent information, and branch transition information, to store the resulting scenario management information in the storage device, and to distribute the scenario management information to a terminal device including a wearable display apparatus in response to a request; to receive response information including audio information and motion information from the terminal device, to convert the audio information into language information, to perform natural language processing on the language information to extract phrase information, emotion information, and persuasiveness evaluation information, and to compute evaluation information including at least clarity, persuasiveness, and a degree of matching to a success pattern by comparing the extracted information with the prediction model and recommended script information; to construct evaluation prompt sentences including the evaluation information and context information, to provide the evaluation prompt sentences as input to the generative artificial intelligence model, and to thereby generate feedback information including concrete improvement points and alternative expression examples for a user utterance; to determine next utterance information of the virtual counterpart by using the branch transition information of the scenario management information or by supplying next-step prompt sentences to the generative artificial intelligence model, and to transmit both the feedback information and the next utterance information to the terminal device; and to store, as learning-record information in the storage device, the historical information, the response information, the evaluation information, and the feedback information, and to periodically retrain the prediction model and update prompt-sentence generation rules for the generative artificial intelligence model based on the learning-record information. This enables the computer system to dynamically generate and adapt dialog scenarios and feedback content based on empirically learned success patterns, to manage dialog states in a machine-readable and branch-aware form, and to continuously improve the behavior of both predictive and generative components, thereby enhancing the technical performance, adaptability, and training effectiveness of the underlying computer-implemented interaction platform.

The term “historical information” refers to data records stored in a storage device that describe past interactions, including at least sales activities, and that include, for each interaction, information such as context, content of utterances, and an indication of success or failure.

The term “feature information” refers to numerical or categorical data elements derived from historical information by preprocessing and transformation, which are suitable for use as input variables to a statistical or machine learning model.

The term “identification information indicating success or failure” refers to label data associated with each interaction record that classifies the outcome of the interaction into at least a success state or a failure state.

The term “statistical learning processing” refers to a computational procedure by which a processor fits a mathematical model to data by optimizing model parameters according to a predefined objective function using the feature information and the identification information indicating success or failure.

The term “prediction model” refers to a trained mathematical or machine learning model generated by statistical learning processing, which receives feature information as input and outputs at least a value representing a probability or likelihood that a given interaction will result in success.

The term “feature information that contributes to success” refers to those components of feature information that the prediction model determines, based on learned parameters or importance metrics, to have a positive influence on a probability of success.

The term “prompt sentence” refers to a structured text string or sequence of tokens generated by a processor and supplied as input to a generative artificial intelligence model to condition or control the behavior and output of the generative artificial intelligence model.

The term “generative artificial intelligence model” refers to a machine learning model configured to generate output data, including at least natural language text, in response to input data such as prompt sentences, based on patterns learned from training data.

The term “scenario information” refers to data generated by the generative artificial intelligence model that defines a dialog flow, including at least utterances, roles, and response patterns for a virtual counterpart in an interaction.

The term “virtual customer” refers to an artificial interaction counterpart modeled and generated by a computer system, which behaves in a manner resembling a customer in a sales or service interaction, and whose utterances and responses are defined by scenario information.

The term “response pattern” refers to a set of rules or data that specify how a virtual customer is to respond to utterances or actions of a user under particular dialog conditions.

The term “machine-readable format” refers to a structured data representation, such as a markup or serialized data structure, that can be parsed, interpreted, and processed by a computer program without human intervention.

The term “dialog turn” refers to a unit of interaction in a dialog, typically comprising one utterance or action by a participant, such as the virtual customer or the user, and optionally associated metadata.

The term “utterance information” refers to data representing a spoken or written expression produced by a dialog participant, including at least the content of the expression and optionally timing or prosody information.

The term “assumed user-intent information” refers to data that represent an estimation or classification of the intention or purpose underlying a user's utterance in a dialog.

The term “branch transition information” refers to data defining conditional transitions between dialog turns, specifying which next turn or state is to be selected based on interaction conditions, such as user responses or evaluation results.

The term “scenario management information” refers to structured data stored in a storage device that collectively represent scenario information, utterance information, assumed user-intent information, branch transition information, and associated metadata for controlling a dialog.

The term “terminal device” refers to an information processing apparatus, distinct from a server, that communicates with the server, executes presentation and input functions, and interfaces with a user.

The term “wearable display apparatus” refers to a device configured to be worn on a user's body, including at least a display function for presenting visual information in the user's field of view, and optionally an audio input/output function.

The term “response information” refers to data transmitted from a terminal device to a processor, including at least audio information and optionally motion information acquired from a user during an interaction.

The term “audio information” refers to data representing sound signals captured from a user, including at least speech used for interacting with a virtual customer.

The term “motion information” refers to data representing physical movements of a user, such as gestures, head movements, or other body motions, acquired by sensors of a terminal device.

The term “language information” refers to data obtained by converting audio information into a text representation or other linguistic representation suitable for natural language processing.

The term “natural language processing” refers to computational processing applied to language information, including at least tokenization, syntactic or semantic analysis, and extraction of linguistic features.

The term “phrase information” refers to data specifying sequences of words or expressions detected in language information that form meaningful linguistic units.

The term “emotion information” refers to data representing an estimated emotional state or tone associated with language information, such as positive, negative, or neutral sentiment or affective categories.

The term “persuasiveness evaluation information” refers to data representing an assessment of how convincing or effective a user's utterance is in the context of an interaction.

The term “evaluation information” refers to data generated by a processor that quantify or describe one or more evaluation dimensions of a user's utterance, including at least clarity, persuasiveness, and a degree of matching to a success pattern.

The term “recommended talk-script information” refers to data that define one or more model or reference utterances and dialog structures that are deemed desirable or effective for achieving successful outcomes.

The term “evaluation prompt sentence” refers to a prompt sentence that includes evaluation information and contextual information, and that is provided as input to a generative artificial intelligence model to cause the model to generate feedback information.

The term “feedback information” refers to data generated by a generative artificial intelligence model that provide a user with comments, improvement points, and alternative expression examples concerning the user's utterance.

The term “next-step prompt sentence” refers to a prompt sentence provided to a generative artificial intelligence model to cause the model to generate a subsequent utterance or behavior for a virtual customer in continuation of a dialog.

The term “next utterance information” refers to utterance information representing a subsequent expression of the virtual customer, determined by a processor using branch transition information or output from a generative artificial intelligence model.

The term “learning-record information” refers to data stored in a storage device that include at least historical information, response information, evaluation information, and feedback information accumulated over multiple interactions, and that are used for retraining or updating models.

The term “retraining of the prediction model” refers to an operation in which a processor uses learning-record information to adjust parameters of an existing prediction model or to generate an updated prediction model.

The term “prompt-sentence generation rule” refers to data or logic used by a processor to determine the structure, content, and parameterization of prompt sentences supplied to a generative artificial intelligence model.

The term “integrated learning data” refers to data formed by associating results of virtual environment interactions with results of real environment interactions, and combining them into a unified training dataset.

In one embodiment, a server, a terminal, and a user cooperate to implement a computer-implemented interaction platform that generates, presents, and adapts virtual-customer dialog scenarios and feedback information based on empirically learned success patterns.

The server includes at least one programmable processor, a main memory, a non-transitory storage device, and a network interface. The server executes a software stack including an operating system, a database management system, a machine learning framework, and an application program. For example, the server executes a general-purpose operating system, a relational or document-oriented database management system, a numerical computation library, a machine learning library, and a natural language processing library. The server further accesses a generative AI model implemented, for example, as a transformer-based neural network deployed on a separate accelerator device such as a graphics processing unit or a tensor processing unit. The server communicates with the generative AI model via an application programming interface over a communication network.

The server stores, in the storage device, historical information representing past interactions including at least sales activities. The historical information includes, for each interaction instance, structured fields such as timestamps, product category identifiers, customer segment identifiers, outcome labels indicating success or failure, and numerical measurements such as interaction duration and number of objections. The server additionally stores unstructured text fields such as transcripts of sales talks and remarks by operators.

The server applies a feature-extraction and normalization process to the historical information. The server uses a machine learning library to encode categorical identifiers into one-hot or embedding vectors, and to compute numerical features including, for example, counts of certain persuasive phrases, sentiment scores derived from a natural language processing library, and statistical summaries of interaction timing. The server normalizes the numerical features using a scaling algorithm, such as standardization to zero mean and unit variance, to improve numerical stability and convergence of later learning processes.

The server generates a prediction model by executing statistical learning processing on the normalized feature information and the associated success/failure labels. In one embodiment, the server trains a gradient-boosted decision tree model and computes feature importances by measuring the contribution of each feature to reduction of an impurity metric such as Gini impurity or information gain. In another embodiment, the server trains a feed-forward neural network with multiple fully connected layers, rectified linear unit activation functions, and an output layer with a sigmoid activation to estimate the probability that a given feature vector corresponds to a successful interaction. The server minimizes a loss function such as binary cross-entropy by performing iterative weight updates using a gradient-based optimization method, for example, stochastic gradient descent with momentum or Adam. During training, the server uses techniques such as mini-batching, dropout regularization, and early stopping to reduce overfitting and to improve generalization performance.

The server derives feature information that contributes to success by analyzing the trained prediction model. When the prediction model is a gradient-boosted decision tree, the server extracts feature importance scores directly from the trained ensemble. When the prediction model is a neural network, the server computes saliency values or uses permutation importance to estimate the effect of perturbing each feature on the predicted success probability. The server selects features whose importance scores exceed a threshold and identifies them as high-contribution features.

The server generates a prompt sentence for the generative AI model based on the high-contribution features. The server maintains rule-based mappings from high-contribution features to linguistic elements of a prompt sentence. For example, when the prediction model indicates that emphasizing warranty benefits and flexible payment terms strongly correlates with success for a certain customer segment, the server encodes these aspects as conditions in the prompt sentence. The server constructs the prompt sentence as plain text, for instance:
“Generate a role-playing dialog scenario between a sales staff member and a cautious customer in the home electronics domain. The customer is sensitive to price but responds well to explanations about warranty benefits and flexible payment options. Create a multi-turn dialog where the customer initially expresses concern about cost, and include realistic questions about warranty coverage and payment plans.”

The server supplies the prompt sentence as input to the generative AI model. The generative AI model operates, for example, as a transformer-based language model with multiple self-attention layers, positional encodings, and feed-forward sublayers. The generative AI model has been pre-trained on large-scale text corpora using an objective such as masked language modeling or next-token prediction, and may be fine-tuned on domain-specific dialog data.

The generative AI model receives the prompt sentence as a token sequence and computes, at each layer, contextual representations by applying attention mechanisms with learned projection matrices. The generative AI model then autoregressively predicts subsequent tokens conditioned on the prompt sentence and previously generated tokens. The server uses decoding strategies such as beam search, top-k sampling, or nucleus sampling to generate coherent and diverse dialog content.

The server structures the generated content into scenario information. The server parses the generated text by identifying speaker tags such as “Customer:” and “Sales Staff:”, segmenting the text into dialog turns. For each dialog turn, the server creates a record that includes utterance information, a speaker role flag, and optionally an assumed user-intent label inferred from keywords or from a lightweight classifier. The server then creates branch transition information, which may include deterministic transitions (e.g., always proceed to the next turn) or conditional transitions based on the user's future response classifications, such as “if user confirms purchase, go to closing branch; if user raises objection, go to objection-handling branch.” The server stores these records in the storage device as scenario management information, for example as JSON-like objects or relational records.

The terminal includes a communications module, a local processor, a memory, sensors, and a wearable display apparatus. The wearable display apparatus comprises a near-eye display module, such as an optical see-through display or a microdisplay with waveguides, and audio input/output circuitry including at least a microphone and a speaker or bone-conduction transducer. The terminal executes an application that communicates with the server using a network protocol such as HTTPS, requesting appropriate scenario management information based on user identification, skill level, or training mode.

The terminal receives the scenario management information and stores it in local memory.

The terminal renders the virtual customer's utterance information in a main display area of the wearable display apparatus and, when available, displays hints or system messages in a secondary area. The terminal may also convert the utterance text into synthesized speech using a text-to-speech engine running locally or hosted on the server, thereby providing auditory output to the user. Because the scenario management information is machine-readable and includes explicit branch transition information, the terminal can maintain a fine-grained dialog state locally and can quickly determine which utterance information to present next by following the branch transition information. This local state tracking reduces the volume of information that must be requested from the server, thereby reducing communication load and latency.

The user wears the wearable display apparatus and perceives the virtual customer's utterances overlaid on the real environment. The user listens to the synthesized voice and/or reads the textual utterances and then responds verbally. The user can also perform natural gestures, such as nodding or raising a hand, which are detected by motion sensors of the terminal, including inertial measurement units or cameras.

The terminal captures the user's speech via the microphone and digitizes the audio signal.

The terminal may perform local pre-processing such as noise reduction and voice activity detection to segment the audio into utterances. The terminal converts the audio into language information using an automatic speech recognition engine. The terminal attaches metadata such as scenario identifier, dialog turn index, and timestamps, forming response information.

The terminal transmits the response information to the server over the network.

The server receives the response information and applies natural language processing. The server uses a natural language processing library to perform tokenization, part-of-speech tagging, dependency parsing, and named entity recognition on the language information. The server computes phrase information by detecting noun phrases, verb phrases, and multi-word expressions. The server further computes emotion information by applying a sentiment analysis classifier or a fine-tuned neural network that outputs probabilities over emotion categories (e.g., confident, hesitant, apologetic). The server calculates persuasiveness evaluation information by matching extracted phrases against recommended talk-script information and by measuring coverage of key benefit elements identified from the high-contribution features.

The server aggregates these quantities into evaluation information. The server computes a clarity score by measuring sentence length, syntactic complexity, and the presence of filler words. The server computes a persuasiveness score by counting aligned persuasive phrases and weighing them by the importance scores derived from the prediction model. The server computes a degree-of-match score to a success pattern by passing the user's feature representation through the prediction model and using the resulting success probability. The server stores the evaluation information in the storage device as part of learning-record information.

The server constructs an evaluation prompt sentence that includes the user's utterance, the virtual customer's preceding utterance, and a compact representation of the evaluation information. For example, the server may generate a prompt sentence such as:
“Evaluate the following sales reply to a customer who is concerned about price and warranty. Consider the scores: clarity=0.6, persuasiveness=0.4, success pattern match=0.5. Explain specific weaknesses and propose three improved example sentences. Customer's last utterance: ‘The price seems high, and I'm not sure about the warranty coverage.’ Sales staff's reply: ‘It's a good product, many people like it.’”

The server supplies the evaluation prompt sentence as input to the generative AI model. The generative AI model processes the prompt and generates feedback information, including an explanation of detected weaknesses (e.g., lack of concrete benefits, failure to address warranty) and specific alternative expressions. The server then sends the feedback information to the terminal.

The terminal displays the feedback information in a sub-display area of the wearable display apparatus while maintaining the main display area for the ongoing dialog. The terminal may allow the user to scroll through the feedback by using a touchpad or gesture interface.

Because the feedback is produced based on detailed numerical evaluation information and contextual dialog content, it is more specific and actionable than generic rule-based feedback. The server determines next utterance information of the virtual customer by referring to the branch transition information stored in the scenario management information and by considering evaluation results. For example, if the evaluation information indicates that the user has adequately addressed price concerns but not warranty concerns, the server selects a branch in which the virtual customer raises a follow-up question specifically regarding warranty. In another embodiment, the server generates the next utterance by creating a next-step prompt sentence that combines the scenario context, the user's last utterance, and the evaluation information, and by providing this prompt sentence to the generative AI model.

The server then receives a generated virtual customer utterance and stores it as next utterance information.

The server sends the next utterance information to the terminal. The terminal updates the dialog state and presents the new virtual customer utterance to the user. The interaction thus proceeds iteratively, with the server continuously updating learning-record information that includes the user's response information, evaluation information, feedback information, and selected dialog branches.

The server periodically retrains the prediction model and updates prompt-sentence generation rules based on accumulated learning-record information. The server aggregates multiple sessions into a training dataset that includes simulated interactions with virtual customers and, where available, real-world sales outcomes associated with particular users or interaction patterns. The server forms integrated learning data by associating simulated interaction patterns with later real-world success/failure results. The server uses this integrated learning data to retrain the prediction model and to adjust weights or rules that map high-contribution features to elements of prompt sentences. In the case of a neural network prediction model, the server continues to minimize the cross-entropy loss on the expanded dataset, updating network weights. In the case of the generative AI model, the server may adjust prompt templates or employ techniques such as reinforcement learning from human feedback-like signals derived from success/failure outcomes.

Because the server uses explicit model-based importance analysis to construct prompt sentences and uses machine-readable scenario structures with branch transitions, the computer system improves internal data management and computation efficiency. The server can reuse existing scenario building blocks for different users by modifying only the prompt sentences according to updated feature importances, thereby avoiding the need to regenerate complete scenarios from scratch. The explicit branch transition information allows the terminal and server to resolve the next dialog state using simple conditional checks, reducing the number of network round trips and enabling faster response times.

The technical effects of this configuration include improved accuracy of success-probability estimation due to model training on feature-normalized data, reduced latency and bandwidth usage due to local state tracking and structured scenario management, and enhanced quality and specificity of feedback by combining predictive model outputs with generative AI outputs in a controlled manner. The server and terminal thus perform operations that are not mere automation of human mental steps, but rather implement a particular data structure design, model training procedure, and prompt generation mechanism that collectively improve the operation of the computer-based training platform.

In alternative embodiments, the server may employ different types of prediction models, such as convolutional neural networks applied to sequence-encoded dialog features, or recurrent neural networks for modeling temporal dependencies across dialog turns. The generative AI model may be hosted locally on the server or on a separate inference appliance within the same data center to reduce network latency. The terminal may be a head-mounted display, smart glasses, or another type of wearable display apparatus with varying field-of-view and interaction modalities. The automatic speech recognition function may be executed entirely on the terminal to avoid transmitting raw audio, thereby reducing network load and improving privacy, or partly on the server to utilize more powerful models.

In further embodiments, the server may adjust the decoding parameters of the generative AI model, such as temperature or beam width, as a function of the user's skill level or of a desired difficulty setting, so that more advanced users receive virtual customer behavior that is less predictable and more challenging. The server may also maintain separate sets of recommended talk-script information for different domains or languages, and select the appropriate set based on user configuration.

Through these configurations, the server and the terminal cooperate to implement a concrete, technically structured system in which data flows, model architectures, and prompt sentences are explicitly organized and optimized. This arrangement enables improvements in computational efficiency, data management, and interaction realism that are rooted in specific technical features of the computer system rather than in generic automation of sales training practices.

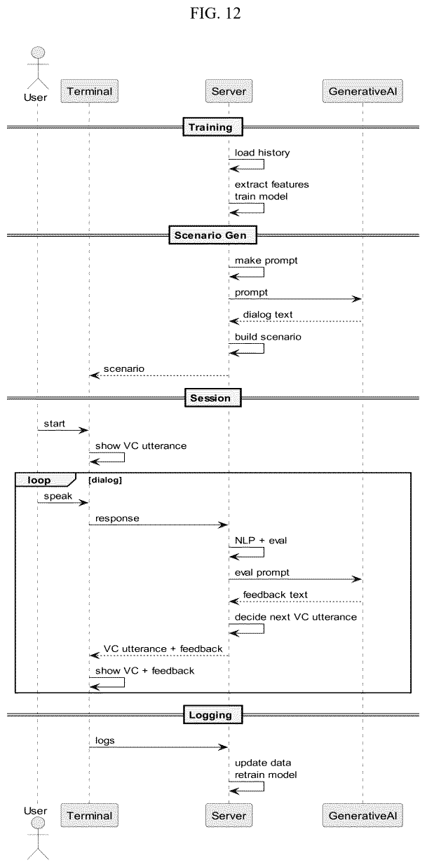

The following describes the processing flow using FIG. 12.

### Step 1:

Server acquires historical information from a storage device.

Server uses a database interface to issue queries and read interaction records including timestamps, product category identifiers, customer segment identifiers, transcripts of dialogs, and success/failure labels.

Input: raw historical records stored in a database or file system.

Server parses these records into an internal tabular structure, removes corrupted or incomplete entries, and standardizes formats of date, numeric fields, and categorical codes.

Output: a cleaned dataset of historical interactions represented as a structured table in main memory.

### Step 2:

Server generates feature information and normalizes it.

Server applies text-processing functions to the dialog transcripts to compute counts of key phrases, sentiment scores, and lengths of utterances; and encodes categorical identifiers as one-hot vectors or dense embeddings.

Input: cleaned dataset of historical interactions.

Server concatenates numerical features, encoded categorical features, and text-derived features into fixed-length feature vectors, then applies a scaling algorithm to normalize each feature dimension.

Output: a feature matrix and a corresponding label vector indicating success or failure for each interaction.

### Step 3:

Server trains a prediction model to estimate success probability.

Server uses the feature matrix and label vector to perform statistical learning, for example by training a gradient-boosted tree ensemble or a feed-forward neural network with a sigmoid output.

Input: normalized feature matrix and label vector.

Server divides the data into training and validation subsets, iteratively updates model parameters by minimizing a loss function such as binary cross-entropy using gradient-based optimization, and evaluates performance using metrics such as accuracy and AUC.

Output: a trained prediction model that outputs a success probability given a feature vector, and associated importance scores for individual features.

### Step 4:

Server derives high-contribution features from the prediction model.

Server analyzes model parameters or importance metrics to identify features that most strongly increase predicted success probability.

Input: trained prediction model and feature descriptions.

Server computes an importance score for each feature (for example, based on split gains in tree models or gradient-based saliency in neural networks), filters features whose scores exceed a threshold, and ranks them in descending order.

Output: a list of high-contribution features with associated importance scores.

### Step 5:

Server generates a prompt sentence for a generative AI model.

Server maps high-contribution features to textual conditions such as preferred benefit types, objection categories, customer traits, and dialog difficulty levels.

Input: list of high-contribution features and domain-specific mapping rules.

Server inserts these conditions into a prompt template and concatenates them into a natural language instruction, for example:
“Generate a role-playing dialog scenario between a sales staff member and a cautious customer in the home electronics domain. The customer is sensitive to price but responds well to explanations about warranty benefits and flexible payment options. Create a multi-turn dialog where the customer initially expresses concern about cost, and include realistic questions about warranty coverage and payment plans.”

Output: a prompt sentence that encodes scenario conditions derived from success-related patterns.

### Step 6:

Server generates scenario information using the generative AI model.

Server sends the prompt sentence to the generative AI model via an API, along with decoding parameters such as maximum length, temperature, and top-k or nucleus sampling thresholds.

Input: prompt sentence and decoding parameters.

Server receives generated text from the generative AI model, which has been computed by applying attention-based transformations over token embeddings and autoregressively predicting next tokens based on the learned parameters and the prompt context.

Output: raw generated dialog text comprising multiple turns between a virtual customer and a sales staff member.

### Step 7:

Server structures the generated dialog into scenario management information.

Server parses the generated text to detect speaker tags and dialog boundaries, and splits the text into discrete dialog turns.

Input: raw generated dialog text.

Server creates, for each turn, a record that includes utterance information (text), a speaker role flag, and optionally an assumed user-intent label computed by a classifier or keyword rules; then constructs branch transition information by defining next-turn indices and conditions based on predefined branching templates.

Output: scenario management information in a machine-readable format that links dialog turns, utterances, assumed intents, and branch transitions.

### Step 8:

Server stores and serves the scenario management information.

Server writes the scenario management information into the storage device with a unique scenario identifier, difficulty level, and metadata.

Input: scenario management information in memory.

Server exposes a network endpoint that accepts requests from terminals, retrieves the requested scenario based on criteria such as scenario identifier and user profile, and serializes the information into a network-transmissible format.

Output: serialized scenario management information ready for transmission to a terminal.

### Step 9:

Terminal retrieves scenario management information from the server.

Terminal establishes a secure network connection, authenticates the user session, and sends a scenario request including at least a user identifier and desired training mode.

Input: user profile data and scenario request parameters.

Terminal receives the serialized scenario from the server, deserializes the data into in-memory structures, and stores references to dialog turns, utterances, and branch transitions in local memory.

Output: locally accessible scenario management data on the terminal.

### Step 10:

Terminal presents virtual customer utterances on the wearable display apparatus.

Terminal selects the initial dialog turn according to the scenario's starting state and renders the virtual customer's utterance in a main display area as overlay text; optionally, the terminal sends the text to a text-to-speech module to generate audio output.

Input: current dialog state and associated utterance information.

Terminal updates the near-eye display pixels to show the text in a legible font and position, synchronizes audio playback if enabled, and maintains an internal pointer to the active turn index.

Output: visual and, optionally, auditory presentation of the virtual customer's utterance to the user.

### Step 11:

User perceives the scenario and prepares a response.

User reads the text shown on the wearable display or listens to the synthetic voice, interprets the virtual customer's question or objection, and mentally plans a response strategy.

Input: visual and/or auditory information from the terminal.

User decides which product benefits, pricing explanations, or reassurance statements to use in the next utterance based on the presented situation.

Output: an internal decision by the user regarding a spoken reply.

### Step 12:

User provides a response via speech and gestures.

User speaks a natural-language reply and may perform gestures such as nodding or pointing that are detectable by the terminal's sensors.

Input: prompt from the virtual customer's latest utterance.

User articulates sentences describing product features, addressing concerns, or attempting to close the sale, and completes the utterance.

Output: acoustic signals and physical motion captured by the terminal.

### Step 13:

Terminal captures and converts the user's response into language information.

Terminal records audio from the microphone, segments it into utterances based on voice activity detection, and optionally filters background noise.

Input: raw audio waveform and motion sensor data from the user.

Terminal sends the audio segment to an automatic speech recognition engine or executes a local recognition algorithm to convert the waveform into a text transcript; then it combines the transcript with metadata such as scenario identifier, turn index, timestamp, and motion indicators into response information.

Output: response information containing language information, motion information, and contextual metadata.

### Step 14:

Server receives and analyzes the user's response.

Server obtains the response information from the terminal and extracts the language information, motion indicators, and context fields.

Input: response information transmitted from the terminal.

Server applies natural language processing operations including tokenization, part-of-speech tagging, phrase chunking, and sentiment analysis to derive phrase information and emotion information; and uses rule-based or model-based checks to identify presence of recommended phrases and objection-handling patterns.

Output: intermediate linguistic feature sets representing the content and tone of the user's reply.

### Step 15:

Server computes evaluation information based on the prediction model.

Server converts the intermediate linguistic feature sets, along with additional numeric features such as response length and gesture indicators, into a feature vector compatible with the prediction model.

Input: linguistic feature sets, motion indicators, and the trained prediction model.

Server feeds the feature vector into the prediction model to obtain a success probability, calculates clarity and persuasiveness scores using heuristic metrics and counts of aligned recommended phrases, and aggregates these values into evaluation information that includes at least clarity, persuasiveness, and degree-of-match to a success pattern.

Output: evaluation information associated with the user's most recent utterance.

### Step 16:

Server generates an evaluation prompt sentence for the generative AI model.

Server embeds the evaluation information, together with the virtual customer's last utterance and the user's reply, into a structured textual instruction.

Input: evaluation information, previous dialog context, and user response text.

Server constructs a prompt sentence, for example:
“Evaluate the following sales reply to a customer who is concerned about price and warranty.

Consider the scores: clarity=0.6, persuasiveness=0.4, success pattern match=0.5. Explain specific weaknesses and propose three improved example sentences. Customer's last utterance: ‘The price seems high, and I'm not sure about the warranty coverage.’ Sales staff's reply: ‘It's a good product, many people like it.’”

Output: an evaluation prompt sentence for conditioning the generative AI model.

### Step 17:

Server generates feedback information using the generative AI model.

Server sends the evaluation prompt sentence to the generative AI model and requests a detailed critique and improved example phrases.

Input: evaluation prompt sentence and generation parameters for the generative AI model.

Server receives generated text that includes explanations of weaknesses, specific improvement points, and alternative expressions, and encapsulates this text as feedback information linked to the current dialog turn.

Output: feedback information tailored to the user's utterance and the scenario context.

### Step 18:

Server determines the next virtual customer utterance.

Server examines the scenario management information and the evaluation information to choose an appropriate branch transition, or, alternatively, forms a next-step prompt sentence summarizing the current state and user performance.

Input: scenario management information, evaluation information, and dialog state.

Server either selects a pre-defined next utterance from the scenario based on branch transition conditions or calls the generative AI model with the next-step prompt sentence to generate a new virtual customer utterance; then it stores the selected or generated text as next utterance information.

Output: next utterance information representing the upcoming virtual customer response.

### Step 19:

Server transmits the next utterance information and feedback information to the terminal.

Server packages the next virtual customer utterance and the feedback text into a response payload, including updated dialog state identifiers.

Input: next utterance information and feedback information.

Server sends the payload to the terminal over the network using a structured message format.

Output: a network message enabling the terminal to update both dialog display and feedback display.

### Step 20:

Terminal presents the next virtual customer utterance and feedback to the user.

Terminal receives the response payload, updates its internal dialog state pointer, and renders the new virtual customer utterance in the main display area of the wearable display apparatus.

Input: response payload from the server.

Terminal displays the feedback information in a sub-display area, optionally highlighting key phrases, and allows user-controlled scrolling or toggling while continuing the dialog; the terminal may also synthesize and play audio for the new utterance.

Output: updated visual and auditory scene that simultaneously conveys the continuation of the dialog and real-time feedback.

### Step 21:

Server logs the interaction into learning-record information.

Server stores the user's response information, the evaluation information, the feedback information, and the selected branch transitions as a new record appended to the learning history.

Input: response information, evaluation information, feedback information, and scenario state data.

Server aggregates these records over time into learning-record information that includes both simulated and real interaction traces, indexed by user, scenario, and time.

Output: an updated learning-record dataset used for later retraining and system optimization.

### Step 22:

Server periodically retrains the prediction model and updates prompt-sentence generation rules.

Server schedules batch jobs that read the accumulated learning-record information, optionally associate it with real-world outcome data, and construct integrated learning data.

Input: learning-record information and, when available, real-world outcome labels.

Server re-executes the feature extraction and model training pipeline to refine the prediction model, recalculates feature importances, and adjusts mapping rules that translate high-contribution features into components of prompt sentences; the updated models and rules are then stored and activated for subsequent sessions.

Output: an updated prediction model and revised prompt-sentence generation rules that improve scenario realism and feedback quality in future interactions.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In the field of computer-implemented training systems for sales activities, conventional technologies typically use static dialogue scripts or generative models that are trained once and then deployed without a reliable, automated mechanism for incorporating real user interaction data back into the model. In such systems, a processor often executes a generative AI model that responds to user input, but the underlying data flow from live interactions to model updating is fragmented, manual, or entirely absent. As a result, the artificial-intelligence customer tends to produce outdated or suboptimal responses that do not reflect current sales trends, emerging customer objections, or recent successful strategies in actual practice.

Furthermore, in many existing systems, interaction logs are stored merely as unstructured text, without systematic preprocessing, tokenization, or selective weighting based on performance or evaluation signals. This lack of an integrated feedback pipeline makes it difficult for a computer system to efficiently transform raw dialogue streams into high-quality training data suitable for continuous fine-tuning of a generative AI model. Consequently, the computational resources are not effectively utilized, and the model fails to converge toward reaction patterns that maximize training value for users in a simulated sales environment. Additionally, conventional architectures often do not manage model version identifiers in association with dialogue histories and evaluation information, thereby limiting the ability of a computer system to objectively compare response tendencies before and after model updates. Without such association, the system cannot algorithmically determine how well success and failure experiences from sales activities are being reflected in the behavior of the artificial-intelligence customer, nor can it automatically adjust retraining frequency or training-data composition based on quantitative outcomes. This restricts the system's capacity to optimize its own learning loop and degrades the overall efficiency and reliability of the computing platform.

Moreover, existing systems generally lack mechanisms for estimating customer attributes and dialogue-state information from prompt sentences and for dynamically adjusting reaction patterns of the generative AI model according to those estimates. As a result, the artificial-intelligence customer often responds in a generic or context-insensitive manner, which reduces the realism and pedagogical value of the simulated interactions. This also represents an underutilization of the computational capabilities of the processor, since the model's internal patterns are not adaptively controlled using available context signals.

Accordingly, there is a need for an improved computer-implemented system that: (i) automatically collects and structures dialogue information including success and failure experiences related to sales activities; (ii) preprocesses and tokenizes such information into machine-usable training datasets; (iii) continuously retrains and redeploys a generative AI model in a closed-loop fashion; (iv) manages model identification information in association with dialogue histories and evaluation information to control retraining operations; and (v) dynamically adjusts reaction patterns of an artificial-intelligence customer based on estimated customer attributes and dialogue-state information. Such a system would improve the functioning of the computer itself by providing a more efficient, adaptive, and data-driven architecture for managing generative AI models in a simulated sales-training environment.

The specific processing by the specific processing unit 290 of the data processing device 12 in Example 2 is realized by the following means.

The present invention provides a server comprising a processor and a storage, the processor being configured to collect, as time-series dialogue information, prompt sentences from users and response sentences from an artificial-intelligence customer related to sales activities, store the dialogue information as recording information in the storage, preprocess the recording information by removing unnecessary symbols, performing normalization and segmentation, and converting the dialogue information into preprocessed data suitable for use as training data, retrain a generative AI model by using the preprocessed data as input information and update configuration information of the generative AI model, deploy the updated generative AI model and corresponding encoding information to an inference execution environment, acquire a prompt sentence from an external terminal apparatus, input the prompt sentence to the generative AI model to generate a response sentence as the artificial-intelligence customer, transmit the response sentence to the external terminal apparatus, append the prompt sentence and the response sentence as dialogue history to the recording information and accumulate the dialogue history as training data for subsequent preprocessing and retraining, construct a training data set by performing weighting or selection on high-rated dialogue information based on evaluation information included in the recording information, manage identification information of the generative AI model in association with the dialogue history and the evaluation information to compare response tendencies of the generative AI model before and after updating and control at least one of retraining frequency and configuration of the training data set based on a determination result, and estimate attribute information of an assumed customer and state information of a dialogue situation from contents of the prompt sentence to change selection or weighting of a reaction pattern in the generative AI model so as to dynamically adjust the response sentence of the artificial-intelligence customer in a simulation format of sales activities. This enables the computer system to implement a closed-loop, data-driven architecture that continually refines the generative AI model based on real interaction data, automatically manages model versions and training data composition, and adaptively controls reaction patterns according to estimated context, thereby improving the technical performance, responsiveness, and training effectiveness of the server-side generative AI processing.

The term “processor” refers to a hardware computation element, such as a central processing unit or an accelerator, that executes instructions stored in a memory to perform data processing operations defined by a program.

The term “storage” refers to a hardware memory resource, such as a volatile memory or a non-volatile memory, that retains recording information, model parameters, training data, and other digital data used by the processor.

The term “time-series dialogue information” refers to a sequence of interaction records, each including at least one prompt sentence and at least one response sentence, stored together with temporal ordering information such as timestamps or sequence indices.

The term “recording information” refers to structured or semi-structured digital data that represents stored time-series dialogue information, including prompt sentences, response sentences, identifiers, timestamps, and associated metadata.

The term “prompt sentence” refers to text data input by a user, through an external terminal apparatus, that serves as an instruction, query, or utterance provided to a generative AI model.

The term “response sentence” refers to text data output by a generative AI model, representing a generated utterance of an artificial-intelligence customer in reply to a prompt sentence.

The term “artificial-intelligence customer” refers to a virtual dialogue agent implemented by a generative AI model, configured to simulate behavior of a customer in sales-related interactions.

The term “preprocessed data” refers to digital data derived from recording information by at least one operation including symbol removal, normalization, segmentation, or tokenization, and being formatted for use as training data for a generative AI model.

The term “normalization” refers to a processing operation that converts character strings into a standardized representation, including at least one of unifying character encodings, case formats, or punctuation styles.

The term “segmentation” refers to a processing operation that divides text data into units such as sentences, phrases, or tokens according to predetermined rules.

The term “generative AI model” refers to a machine-learned model, such as a probabilistic sequence model or a neural network, configured to generate text data by predicting output tokens based on input tokens.

The term “configuration information of the generative AI model” refers to parameter values, architectural settings, and associated metadata that define operational behavior of the generative AI model.

The term “retraining” refers to a process in which the generative AI model is updated by further learning using additional training data, while at least part of previously learned parameters or structure is retained.

The term “encoding information” refers to data structures, including tokenizer rules, vocabularies, and mapping tables, that specify how text data is converted to numerical representations suitable for processing by a generative AI model.

The term “inference execution environment” refers to a computing environment, including at least one processor and storage, configured to load a trained generative AI model and execute inference operations in response to access requests.

The term “external terminal apparatus” refers to a user-operated computing device, such as a client terminal or mobile terminal, that transmits prompt sentences to a server and receives response sentences over a communication network.

The term “dialogue history” refers to a collection of related prompt sentences and response sentences associated with a session or user, stored together with temporal and contextual metadata.

The term “training data” refers to input-output examples or sequences, derived from preprocessed data or dialogue history, used by a machine-learning program to adjust parameters of a generative AI model.

The term “evaluation information” refers to quantitative or qualitative metrics, including ratings, labels, or feedback indicators, associated with dialogue history and used to assess quality or usefulness of interactions.

The term “training data set” refers to an organized collection of training data selected and optionally weighted based on evaluation information and used as input for retraining a generative AI model.

The term “weighting” refers to assigning different importance values or multiplicities to individual training examples when constructing a training data set, so that certain examples influence the model more than others.

The term “selection” refers to including or excluding particular data elements from a candidate pool of preprocessed data based on predetermined criteria, such as evaluation information or content attributes.

The term “identification information of the generative AI model” refers to a model identifier, such as a version number or unique ID, that distinguishes one trained instance of a generative AI model from another.

The term “response tendencies” refers to statistical or qualitative characteristics of responses generated by a generative AI model, including patterns in content, style, frequency, or outcome.

The term “reflection degree” refers to a measure indicating how strongly success and failure experiences in sales activities are incorporated into behavioral patterns of the generative AI model.

The term “retraining frequency” refers to how often retraining of the generative AI model is executed over a period of time, including scheduling parameters such as intervals or triggers.

The term “configuration of the training data set” refers to composition parameters of the training data set, including which data elements are included, their relative proportions, and their weighting rules.

The term “attribute information of an assumed customer” refers to inferred properties of a virtual customer, such as industry type, organization size, budget sensitivity, or risk tolerance, estimated from a prompt sentence or context.

The term “state information of a dialogue situation” refers to inferred conditions of an ongoing interaction, such as negotiation phase, objection status, sentiment, or prior agreement status.

The term “reaction pattern” refers to a set of internal model behaviors or response-generation profiles of the generative AI model that determine how the artificial-intelligence customer replies under particular conditions.

The term “dynamic response generation behavior” refers to behavior of the generative AI model in which generated responses change adaptively over time based on updated training data, model configuration, or context signals.

The term “simulation format of sales activities” refers to a virtual interaction setting in which dialogues between a user and an artificial-intelligence customer emulate real-world sales processes for training or practice.

In one embodiment, a server, a terminal, and a user cooperate to implement a system for generating and updating an artificial-intelligence customer based on a generative AI model. The server includes at least one processor, such as a central processing unit and optionally at least one hardware accelerator such as a graphics processing unit, and at least one storage device, such as a volatile memory and a non-volatile memory. The server executes computer programs implemented using a programming language such as Python or a general-purpose language, and may employ frameworks such as a web application framework and a machine learning framework. The terminal includes a processor, a memory, a communication interface, and a display device. The terminal may be implemented as a mobile device, a portable information processing device, or a desktop client device.

The server stores a generative AI model in the storage. In one embodiment, the server uses a transformer-based neural network as the generative AI model. The transformer-based neural network includes a plurality of encoder-decoder or decoder-only layers, each layer including at least a multi-head self-attention mechanism and a position-wise feedforward network. The server represents each token of a prompt sentence and a response sentence as a vector in a continuous space, and the server uses positional encodings to preserve token order. The server stores model parameters, including weight matrices and bias vectors, as numerical arrays in the storage. The server also stores encoding information, including a tokenizer configuration and a vocabulary, which define a mapping from character sequences to token identifiers and vice versa. In one embodiment, the server uses a subword tokenization method such as a byte pair encoding method or a similar method.

The server collects dialogue information as time-series dialogue information. The server receives, from the terminal, a prompt sentence input by the user and transmits a response sentence generated by the generative AI model to the terminal. The server stores these prompt sentences and response sentences as recording information in the storage. The recording information further includes metadata such as timestamps, session identifiers, and identifiers of the generative AI model version used to generate the response. The server uses a data store, such as a relational data structure or a key-value data structure, to maintain the association between each prompt sentence, each response sentence, the corresponding session identifier, and the model identification information. This structured data representation enables efficient retrieval and comparison of responses generated by different model versions.

The terminal displays a user interface for interacting with the artificial-intelligence customer. The terminal presents an input field where the user can type a prompt sentence and a display area where the terminal shows the response sentence returned from the server. The terminal transmits the prompt sentence, together with a session identifier and optional evaluation information such as a rating or a label, to the server via a communication network using a communication protocol such as HTTPS. The terminal may allow the user to select specific training scenarios, such as a skeptical customer scenario or a budget-conscious customer scenario, and may append corresponding scenario identifiers to the prompt sentence metadata sent to the server.

The user provides various prompt sentences to train and evaluate the artificial-intelligence customer. For example, the user may input a prompt sentence such as “Please explain the main features of our new product for a first-time corporate customer.” The user may further input more specialized prompt sentences such as “How should I respond if a customer says our product is too expensive compared to competitors?” or “Act as a skeptical procurement manager and ask me questions about security and compliance.” The user may also input follow-up prompt sentences such as “But the customer is concerned about integration costs. How should I address that?” or “Simulate a conversation with a small business owner who is unsure about switching from a competitor's service.” The server logs each of these prompt sentences together with the corresponding response sentences and evaluation information, forming a time-series dialogue history.

The server performs preprocessing on the recording information. The server loads the stored prompt sentences and response sentences into memory and applies a sequence of text-processing operations. The server uses a text-processing library to remove unnecessary symbols, such as non-printable characters, redundant whitespace, or extraneous markup, and to normalize character encodings. The server may perform case normalization or punctuation unification, depending on the requirements of the generative AI model. The server segments the text into tokens using the stored tokenizer configuration. The server may further anonymize the data by replacing specific entity names or sensitive terms with generalized placeholders. The server thus converts raw text and metadata into preprocessed data suitable for use as training data, including token identifiers, attention masks, and labels indicating which tokens correspond to prompt sentences and which tokens correspond to response sentences.

The server constructs training data sets from the preprocessed data. The server arranges token sequences into input-output pairs or single concatenated sequences according to predefined templates. For example, the server may combine a prompt sentence and the corresponding response sentence into a single sequence, separated by special tokens, and designate all positions of the sequence as targets for next-token prediction. The server may also construct multi-turn dialogue sequences by concatenating multiple prompt sentences and response sentences within the same session. The server uses evaluation information, such as user ratings or success/failure labels, to perform selection and weighting. The server may assign higher weights to training examples with high evaluation scores, or may exclude training examples with poor ratings or low-quality interactions. The server records these weights and selections in data structures accessible by the training program.

The server retrains the generative AI model using the constructed training data sets. The server uses a machine learning framework such as a neural network training library to perform gradient-based learning on the model parameters. The server configures an optimization algorithm, such as an adaptive gradient method, and defines a loss function such as a token-level cross-entropy loss between predicted token distributions and actual target tokens. The server initializes a training loop that iteratively loads mini-batches of tokenized sequences and feeds them into the generative AI model. The server computes a forward pass to obtain predicted token probabilities, computes the loss, performs a backward pass to obtain gradients with respect to model parameters, and updates the model parameters according to the optimization algorithm. The server periodically evaluates the model using a validation subset of the training data set to monitor overfitting and adjust training parameters such as learning rate or batch size.

The server stores model identification information for each trained or retrained generative AI model. The server assigns a unique identifier to each model version and records, in the storage, the training data set configuration, the evaluation metrics, and the time of training. The server associates the model identification information with the dialogue histories generated by that model version. This association enables the server to compare response tendencies between model versions. For instance, the server may compute statistics such as average evaluation scores, response length distributions, or error rates for different model versions and may use these statistics to determine whether a new model version reflects success and failure experiences more effectively than a previous version.

The server deploys the updated generative AI model to an inference execution environment. The server loads the updated model parameters and encoding information into memory on one or more inference nodes. The server exposes an inference interface, such as a network-accessible application programming interface, that accepts prompt sentences and returns response sentences. The server may use a container-based execution environment or a virtualized environment to manage different versions of the generative AI model and to perform controlled rollouts or rollbacks. The server may route a subset of inference requests to a candidate model version and collect evaluation information to compare its performance with an existing production model before switching traffic completely.

The server dynamically adjusts reaction patterns of the artificial-intelligence customer based on prompt sentence attributes and dialogue-state information. The server analyzes each incoming prompt sentence to estimate attribute information of an assumed customer, such as risk aversion, cost sensitivity, or expertise level, using statistical features or learned classifiers. The server further estimates state information of the dialogue situation, such as negotiation phase, objection presence, or sentiment polarity, based on text features derived from the dialogue history. The server then adjusts the generative AI model's behavior by, for example, modifying decoding parameters such as temperature or top-p sampling thresholds, selecting different internal prompt templates, or biasing the output distribution toward specific token subsets. This dynamic adjustment results in context-appropriate responses that differ for the same base prompt sentence depending on inferred attributes and dialogue states. The server implements technical measures to improve computational performance and data management beyond mere automation of human tasks. The server reduces redundant data transfer and storage by storing dialogue histories in structured compressed formats and by reusing tokenized representations where possible. The server improves training efficiency by using batch processing, gradient accumulation, and hardware-accelerated matrix operations on graphics processing units. The server reduces communication load by sending compact representations and by controlling update frequency of model deployments based on quantifiable performance improvements. The server achieves higher response quality and lower error rates by selectively weighting training examples with higher evaluation scores. This approach leads to faster convergence of the model and reduces the number of training iterations required for a given performance level, thereby improving overall computational efficiency.

The server employs learning methods and internal rules that are distinct from conventional rule-based or manual operations. Instead of relying on fixed dialogue scripts or static templates, the server continuously updates numerical weights in the generative AI model based on statistical patterns in the collected dialogue histories. The server uses numerical loss values and gradients computed over large data sets to adjust millions or billions of model parameters in a manner that is infeasible for human operators. The server also introduces non-conventional data flows, such as associating model identification information with evaluation-labeled dialogues and using this association to control retraining frequency and training data composition. This control loop enables the server to autonomously adapt the model's behavior to changing usage patterns and sales contexts without requiring manual rule updates.

The terminal benefits from the server's improved computational processes because the terminal receives contextually appropriate and up-to-date response sentences with lower latency and higher reliability. The terminal does not perform heavy computation locally; instead, the terminal communicates concise prompt sentences and receives generated responses. This reduces the resource requirements on the terminal while still enabling complex generative AI functionality. From the user's perspective, the dialogue with the artificial-intelligence customer is more realistic and varied because the server dynamically adjusts reaction patterns based on inferred attributes and updated training data. However, the novelty of the invention lies not in the business logic of sales training itself but in the specific data structures, learning pipelines, and adaptive inference controls implemented within the server to improve technical performance of the generative AI processing.

In another embodiment, the server uses different neural network architectures or learning algorithms. For example, the server may use a recurrent neural network with attention mechanisms instead of a transformer, or a hybrid architecture that combines convolutional layers with self-attention layers. The server may employ alternative optimization algorithms such as stochastic gradient descent with momentum, or may perform distributed training across multiple processors. The server may also employ different data augmentation techniques, such as paraphrasing prompt sentences or injecting synthetic errors, to improve robustness of the generative AI model. These variations still fall within the scope of the invention as long as the server collects dialogue information, preprocesses the information, retrains the generative AI model based on weighted training data sets, associates model identification information with evaluation-labeled histories, and dynamically adjusts reaction patterns according to inferred attributes and dialogue states.

In yet another embodiment, the server integrates additional modules for anomaly detection or quality control. The server may automatically detect degenerate responses, such as excessively repetitive outputs or irrelevant content, by applying statistical thresholds or auxiliary classifiers. The server may then flag or exclude such interactions from the training data set, or may lower their weights in the learning process. This selective handling of anomalous data further improves the accuracy and stability of the generative AI model and reduces the risk of performance degradation due to noisy or adversarial inputs.

Through these configurations, the server improves the functioning of the computer system itself by implementing an integrated, feedback-driven architecture for managing a generative AI model. The server not only executes the model to respond to prompt sentences, but also structures, filters, and leverages interaction data in a technically specific way to update model parameters, manage model versions, and control inference behavior. This yields technical effects in terms of processing speed, accuracy, data management efficiency, and communication overhead reduction that go beyond mere automation of human cognitive tasks.

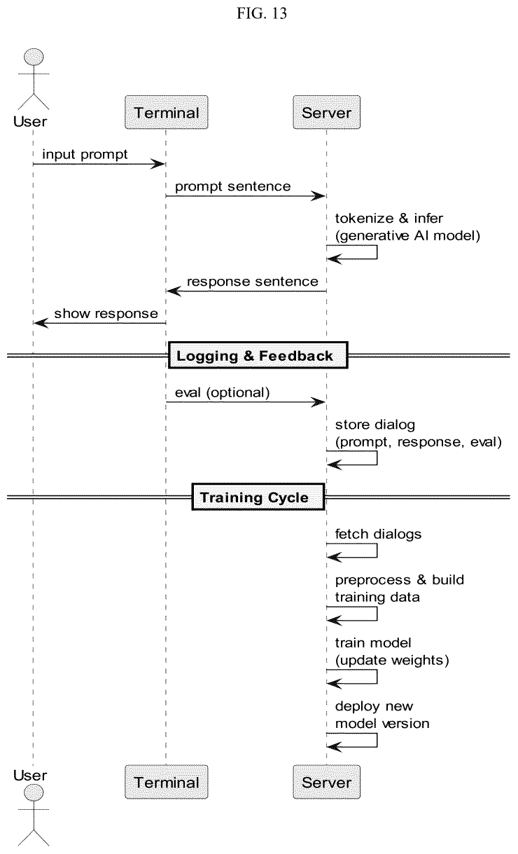

The following describes the processing flow using FIG. 13.

### Step 1:

The server initializes system resources and loads configuration information. The server receives, as input, configuration files stored in a storage device, including database connection parameters, model file paths, tokenizer settings, and API endpoint definitions.

The server parses these configuration files and establishes connections to a data store, such as a relational database, and to a file storage area containing generative AI model parameters and tokenizer vocabularies. The server then loads the generative AI model into main memory and, when available, into an accelerator device memory, and initializes a tokenizer object based on the loaded vocabulary. As output, the server produces an active runtime environment in which the model, tokenizer, and data connections are ready for subsequent dialogue processing, logging, and training.

### Step 2:

The terminal presents a user interface and acquires a prompt sentence from the user. The terminal receives, as input, display definitions and script code delivered from the server when a web page or application is launched. The terminal renders an input field and a conversation area on a display device. The user then types a prompt sentence, for example, “Please explain the main features of our new product for a first-time corporate customer.” The terminal captures the text entered by the user, associates it with a session identifier and a timestamp, and packages these elements into a structured message. As output, the terminal generates a request payload that contains at least the prompt sentence, session identifier, and timestamp, which is then ready to be transmitted to the server.

### Step 3:

The terminal transmits the prompt sentence and session information to the server. The terminal receives, as input, the structured message containing the prompt sentence and metadata. The terminal uses a communication interface to send this message to the server via a network protocol, such as HTTPS. During this transmission, the terminal may compress or encode the data in a specific format, such as JSON over HTTP, to reduce overhead and ensure integrity. As output, the terminal delivers the prompt sentence, session identifier, and associated metadata to the server endpoint designated for inference requests.

### Step 4:

The server receives the prompt sentence and records an initial dialogue entry. The server receives, as input, the request payload sent by the terminal, including the prompt sentence, session identifier, timestamp, and optional evaluation placeholders. The server parses the payload, extracts the prompt sentence and metadata, and performs basic validation, such as checking for empty content or prohibited characters. The server then inserts a new record into a dialogue table or similar data structure in the database, storing at least the prompt sentence, session identifier, model version identifier currently in use, and the receive timestamp. As output, the server produces a stored dialogue entry that serves as the initial half of a dialogue pair, ready to be associated with a generated response sentence.

### Step 5:

The server tokenizes the prompt sentence and prepares it for inference by the generative AI model. The server receives, as input, the prompt sentence text extracted from the request and the tokenizer configuration loaded during initialization. The server applies text pre-processing operations, such as normalization of whitespace and conversion of text encoding if necessary. The server then invokes the tokenizer to convert the prompt sentence into a sequence of token identifiers and corresponding attention masks, using mapping rules defined by a vocabulary. The server may also apply truncation or padding based on a maximum sequence length. As output, the server produces a tokenized representation of the prompt sentence, including token identifier arrays and attention masks, suitable for input to the generative AI model.

### Step 6:

The server generates a response sentence using the generative AI model. The server receives, as input, the tokenized prompt sequence and the current state of the generative AI model parameters in memory. The server feeds the token identifiers and attention masks into the model and executes a forward pass, during which the model performs matrix multiplications and attention computations in multiple layers to produce probability distributions over possible next tokens. The server then applies a decoding strategy, such as greedy decoding or sampling with a temperature and top-p threshold, to select a sequence of output tokens step by step. When the server reaches an end-of-sequence token or a predefined maximum length, the server stops generation and converts the output token identifiers back into a text string using the tokenizer. As output, the server obtains a generated response sentence representing the utterance of the artificial-intelligence customer.

### Step 7:

The server logs the complete dialogue pair and returns the response to the terminal. The server receives, as input, the generated response sentence, the previously stored dialogue entry containing the prompt sentence, and the session identifier. The server updates the database record to append the response sentence, a response generation timestamp, and performance metrics such as generation latency and model version identifier. The server then constructs a response payload that includes at least the generated response sentence and the session identifier. As output, the server sends this payload back to the terminal over the network, thereby completing the prompt-response cycle in the dialogue history.

### Step 8:

The terminal displays the response sentence and acquires optional evaluation information from the user. The terminal receives, as input, the response payload containing the generated response sentence and session identifier. The terminal updates the user interface by appending the response sentence to the conversation area, visually distinguishing it from the user's prompt sentence. The user reads the response and may choose to provide an evaluation, such as selecting a rating, a “useful/not useful” indicator, or a label describing the perceived quality of the response. The terminal captures this evaluation information and associates it with the corresponding session and dialogue entry. As output, the terminal generates a feedback payload that contains the evaluation information and identifiers for the related prompt sentence and response sentence.

### Step 9:

The server stores the evaluation information and enriches the dialogue history. The server receives, as input, the feedback payload from the terminal, including evaluation scores or labels and identifiers referencing the existing dialogue record. The server locates the corresponding dialogue entry in the database and updates it with the received evaluation information. The server may compute additional metrics, such as normalized scores or category labels, derived from the raw evaluation data. As output, the server produces an enriched dialogue history record that includes the prompt sentence, response sentence, timestamps, model version identifier, and the associated evaluation information.

### Step 10:

The server periodically extracts recorded dialogue histories for preprocessing. The server receives, as input, extraction conditions, such as a time window or a flag indicating which records have not yet been used for training. The server queries the database and retrieves a batch of dialogue records that satisfy the conditions, including prompt sentences, response sentences, evaluation information, and metadata. The server loads this batch into main memory and structures it into in-memory data representations, such as arrays or tables. As output, the server prepares a collection of raw dialogue data ready for preprocessing and transformation into training data.

### Step 11:

The server preprocesses the extracted dialogue texts into normalized token sequences. The server receives, as input, the batch of raw dialogue records containing text fields and metadata. The server applies text cleaning operations, including removal of control characters, standardization of whitespace, and unification of punctuation. The server may apply anonymization rules to replace sensitive terms with generic placeholders. The server then tokenizes both prompt sentences and response sentences using the same tokenizer configuration as in inference, producing token identifier sequences and attention masks. The server may create paired sequences, such as concatenated prompt-response sequences separated by special tokens. As output, the server generates preprocessed data structures that represent dialogues in a numerical form suitable for use as training examples.

### Step 12:

The server constructs a training data set with selection and weighting based on evaluation information. The server receives, as input, the preprocessed token sequences and the associated evaluation information for each dialogue record. The server applies selection rules, such as including only dialogues with evaluation scores above a threshold or downsampling dialogues with low evaluation scores. The server also computes weighting factors that assign higher importance to dialogues labeled as successful interactions. The server records these selection and weighting values alongside the token sequences, forming an annotated training pool. As output, the server produces a training data set in which each example is associated with a token sequence, mask information, and a weight indicating its influence on the learning process.

### Step 13:

The server retrains the generative AI model using the constructed training data set. The server receives, as input, the current generative AI model parameters and the training data set with token sequences and weights. The server divides the data into mini-batches and, for each mini-batch, feeds the token sequences into the model to perform a forward pass and obtain predicted token distributions. The server computes a loss value, such as a weighted cross-entropy loss, in which the contribution of each example to the loss is scaled by its assigned weight. The server then performs backpropagation to calculate gradients of the loss with respect to model parameters and applies an optimization algorithm to update those parameters. The server repeats this process for multiple epochs, periodically evaluating the model on a validation subset. As output, the server obtains an updated set of model parameters that reflect the newly incorporated dialogue data and evaluation-guided weighting.

### Step 14:

The server assigns and records identification information for the updated model version. The server receives, as input, the updated model parameters and training metadata, such as training date, number of epochs, and performance metrics. The server generates a unique model version identifier and stores this identifier together with a reference to the model parameter file and the training metadata in the database or another structured store. The server associates the version identifier with a status indicator, such as “candidate” or “production.” As output, the server produces a model version record that can be referenced during future inference, logging, and comparison operations.

### Step 15:

The server deploys the updated model to the inference execution environment and updates routing information. The server receives, as input, the model version record and the updated model parameters stored in the file system. The server loads the updated parameters and tokenizer configuration into the inference runtime process and verifies that inference calls using sample prompt sentences produce valid responses. The server then updates routing rules so that new inference requests from terminals are directed to the updated model version, either immediately or gradually. As output, the server makes the updated generative AI model available to handle future prompt sentences in production, while older versions can be retained for fallback or comparison.

### Step 16:

The server compares response tendencies of different model versions using subsequent dialogue histories. The server receives, as input, new dialogue records generated after deployment, including prompt sentences, response sentences, evaluation information, and the model version identifier used for each response. The server aggregates statistics, such as average evaluation scores or error rates, grouped by model version identifier. The server computes comparison metrics to determine whether the updated model version yields improved responses relative to previous versions. As output, the server produces performance summaries that guide decisions about retraining frequency, training data composition adjustments, and potential rollback or further tuning of the generative AI model.

### Step 17:

The server dynamically adjusts reaction patterns during inference based on inferred attributes and dialogue-state information. The server receives, as input, an incoming prompt sentence, the associated dialogue history for the session, and the current model configuration. The server analyzes text features from the prompt sentence and dialogue history to estimate attributes such as customer type or risk profile, and state information such as negotiation phase or sentiment. The server then modifies inference parameters, such as decoding temperature, top-k or top-p sampling thresholds, or internal conditioning tokens, according to these estimates. The server feeds the adjusted input and parameters into the generative AI model and obtains a response sentence tailored to the inferred context. As output, the server supplies a context-sensitive response that reflects dynamically adjusted reaction patterns of the artificial-intelligence customer.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented training and support systems for sales activities suffer from several technical limitations. First, such systems typically treat dialog content, user behavior, and outcome information as static records and do not continuously integrate these heterogeneous data streams into the core models that generate dialog responses. As a result, the response generation logic is often implemented as fixed rules or static scripts, which limits adaptability to changing user states and prevents efficient reuse of accumulated interaction data at scale. This leads to inefficient utilization of computing resources, because large volumes of dialog logs and result data remain under-exploited for improving the underlying models.

Second, known systems generally do not incorporate real-time emotion recognition into the generative process of dialog responses in a unified computational pipeline. Emotion information, if used at all, is often processed in a separate module and not tightly coupled to the construction of input prompts for a generative AI model. Consequently, the system cannot systematically produce emotion-adaptive responses in a way that is consistent across many sessions and users, and the processing architecture cannot exploit emotion labels as machine-readable features for continuous model retraining. This results in suboptimal quality and stability of generated responses under varying user states.

Third, existing architectures do not provide an integrated mechanism by which human edits of generated responses and empirically observed success probabilities are fed back automatically into both a generative model and a success-probability prediction model.

Trainer corrections and preferences are often applied as local overrides in user interface layers, without being encoded as structured training data. As a result, the system architecture cannot efficiently converge toward higher-quality response policies, and repeated manual editing burdens human operators and increases processing latency.

Fourth, in live customer interactions, conventional support systems either provide static hints or rely on coarse heuristics that are not derived from a unified model of dialog history, user emotion, and predicted success probability. The absence of a coherent, prompt-based integration of real-time input data with a generative AI model leads to fragmented processing paths, increased complexity in application logic, and difficulty in scaling the system to multiple scenarios or domains.

Accordingly, there is a need for an improved computer-implemented system and processing architecture that (i) acquires sales activity results, dialog histories, emotion states, and sales outcomes as structured training data; (ii) uses this data to train and periodically update both a generative AI model and a success-probability prediction model; (iii) dynamically constructs prompt sentences that embed dialog context and emotion information for the generative AI model; (iv) evaluates multiple generated response candidates with a predictive model; and (v) feeds back dialog logs and human edits as retraining data. By addressing these issues, the system can improve the technical performance of automated dialog generation, reduce the need for manual scripting, and provide stable, scalable, emotion-adaptive sales support and training on general-purpose computing hardware.

The specific processing by the specific processing unit 290 of the data processing device 12 in Application Example 2 is realized by the following means.

The present invention provides a server comprising a processor configured to acquire sales activity results, including dialog histories and success/failure information, as a training data set from a storage device; to perform machine learning with a generative artificial intelligence model on the basis of the training data set so as to generate a trained generative model; to generate virtual customer information including attribute information of a virtual dialog entity and a response style by using a learning result of the trained generative model; to construct prompt sentences including dialog situations and sales objectives and to input the prompt sentences into the trained generative model so as to generate virtual dialog responses corresponding to the virtual customer information; to estimate an emotional state of a user on the basis of utterance information and behavior information received from a user terminal; to dynamically reconstruct the prompt sentences by embedding the dialog histories and the estimated emotional state as machine-readable features and to input the reconstructed prompt sentences into the trained generative model so as to generate emotion-adaptive virtual dialog responses; to record, in association with one another, user dialog contents, virtual dialog responses, estimated emotional states, and sales results occurring during sales actions for the virtual customer information, and to accumulate the recorded association as retraining data for the trained generative model and for a success-probability prediction model; to periodically update parameters of the trained generative model and the success-probability prediction model on the basis of the accumulated retraining data so as to adjust, in an automated manner, the response style of the virtual customer information and a sales dialog script; to provide a user interface for presenting candidate virtual responses and their generation conditions on a display device, acquiring edit contents for the candidate virtual responses from the user, storing the edit contents as overwrite rules for the response style, and converting the edit contents into additional training samples for further updating the trained generative model; and to extract recommendation targets on the basis of real customer information and past transaction history obtained during a dialog with a real customer, to construct prompt sentences including the recommendation targets and the dialog histories, to input the constructed prompt sentences into the trained generative model so as to generate explanatory texts for proposals, and to transmit the explanatory texts to the user terminal for presentation to the user. This enables a unified computer-implemented architecture in which dialog histories, emotion information, user feedback, and sales results are continuously integrated into the training and inference pipelines of a generative AI model and a predictive model, thereby improving the technical quality, adaptability, and computational efficiency of automated dialog generation and real-time sales support on general-purpose computing equipment.

The term “sales activity result” refers to machine-readable data representing past sales operations, including at least dialog contents between a salesperson and a customer, contextual information, and outcome information such as success or failure of a sales attempt.

The term “training data set” refers to a collection of structured or semi-structured records used as input for machine learning, the records including sales activity results, dialog histories, and associated labels such as success, failure, or emotion.

The term “dialog history” refers to an ordered sequence of utterances exchanged between two or more dialog parties, together with associated timestamps and metadata, stored in a form that can be processed by an information processing apparatus.

The term “success/failure information” refers to data indicating whether a given sales activity or dialog episode achieved a predefined goal, such as contract conclusion or product purchase, and may include a degree of success.

The term “generative artificial intelligence model” refers to a learned computational model that, when provided with an input sequence including a prompt sentence, automatically generates output data such as natural-language text according to statistical patterns learned from a training data set.

The term “trained generative model” refers to a generative artificial intelligence model whose parameters have been optimized by executing a machine learning algorithm on a training data set so that the model can generate outputs conforming to desired patterns.

The term “virtual customer information” refers to data defining a simulated customer entity, including at least attribute information such as segment, budget level, or preference, and a response style indicating typical dialog behavior.

The term “virtual dialog entity” refers to an artificial dialog participant represented in a computer system, which behaves as a simulated customer in an interaction with a user by generating and receiving dialog utterances.

The term “response style” refers to parameters or rules that characterize how a virtual dialog entity responds, including tone, degree of skepticism, politeness level, and typical patterns of asking questions or raising objections.

The term “prompt sentence” refers to an input string or structured text provided to a generative artificial intelligence model, the input string including context information such as dialog situation, sales objective, and user state, and serving as a condition for generating an output.

The term “dialog situation” refers to information describing a current state of a dialog, including scenario type, phase of the conversation, discussed product or service, and prior utterances relevant to the next response.

The term “sales objective” refers to a predefined target of a sales activity, such as obtaining agreement for a meeting, closing a sale, or introducing an additional product.

The term “virtual dialog response” refers to an output utterance generated by a generative artificial intelligence model on behalf of a virtual dialog entity, in response to a prompt sentence and dialog context.

The term “user terminal” refers to an electronic apparatus operated by a user, such as a portable communication device, a head-mounted display, or a general-purpose computer, capable of transmitting and receiving data to and from a server.

The term “utterance information” refers to data representing spoken or written expressions of a user, including text transcriptions, audio features, or other representations suitable for natural-language analysis.

The term “behavior information” refers to data related to actions or states of a user other than utterances, including facial expressions, gaze direction, gestures, interaction timing, and other measurable cues.

The term “emotional state” refers to an estimated affective condition of a user, such as joy, anger, confusion, or satisfaction, derived from utterance information, behavior information, or both by an emotion estimation algorithm.

The term “emotion-adaptive virtual dialog response” refers to a virtual dialog response generated by a generative artificial intelligence model in which the content, tone, or structure is modified in accordance with an estimated emotional state of a user.

The term “retraining data” refers to data that has been collected after an initial training phase, including new dialog logs, emotional states, and sales results, which is used to further train or fine-tune an already trained model.

The term “success-probability prediction model” refers to an information processing model that, when given features derived from dialog history, user state, and context, outputs a numerical estimate representing the probability that a sales objective will be achieved.

The term “sales dialog script” refers to a machine-readable template or sequence of recommended utterances to be used in a sales conversation, which can be generated or modified by an information processing model.

The term “candidate response” refers to one of a plurality of alternative virtual dialog responses generated by a generative artificial intelligence model from the same or similar prompt sentence.

The term “generation condition” refers to metadata indicating conditions used to generate a candidate response, including scenario type, embedded emotional state, and model parameters.

The term “overwrite rule” refers to a machine-readable specification that modifies or replaces a default response style or generated output according to edited content provided by a user.

The term “display device” refers to an output apparatus capable of presenting visual information to a user, such as a flat-panel display, a head-mounted display, or smart glasses.

The term “real customer information” refers to data relating to an actual customer of a sales activity, including demographic attributes, preference indicators, and identifiers linkable to transaction records.

The term “past transaction history” refers to records of previous commercial dealings with a real customer, including purchased items, dates, prices, and related contextual information.

The term “recommendation target” refers to an item, service, or option selected as a candidate for proposal to a real customer on the basis of real customer information and past transaction history.

The term “explanatory text for a proposal” refers to natural-language content generated by a generative artificial intelligence model that describes features, benefits, or conditions of a recommendation target for presentation to a user.

The term “sales support advice information” refers to output data that suggests an action, phrase, or strategy to a user engaged in a sales dialog, derived at least in part from a generative artificial intelligence model and associated predictive models.

The term “visual display device” refers to a display device arranged to present imagery or text in a manner directly observable by a user, and may include see-through or non-see-through wearable displays.

The term “overlapping display” refers to presentation of information on a visual display device such that generated guidance, hints, or text are superimposed on or adjacent to other visual content perceived by the user.

In one embodiment, a server executes a set of software modules on general-purpose computing hardware to implement the claimed system. The server includes at least one multi-core central processing unit, a graphics processing unit configured for tensor operations, a volatile memory unit, a non-volatile storage unit, and a network interface. The server executes an operating system, a database management system, a machine-learning framework, and application programs written in a high-level programming language.

The server uses a relational database management system to store sales activity results, dialog histories, emotional state labels, and model parameters. The server stores dialog histories as records in a dialog table, where each record includes a session identifier, a turn index, a speaker flag, a text field, a timestamp, and foreign keys to an emotion table and an outcome table. The server stores emotion labels in the emotion table, where each record includes an emotion identifier, a categorical label, and a continuous score vector produced by an emotion classifier. The server stores model parameters of a generative AI model and of a success-probability prediction model in a model table, encoded as binary arrays or serialized parameter vectors.

The server uses a machine-learning framework to implement the generative AI model and the success-probability prediction model. The generative AI model, in one embodiment, is a Transformer-based neural network comprising an embedding layer, a stack of self-attention blocks, and an output projection layer. Each self-attention block includes multi-head scaled dot-product attention units and position-wise feed-forward networks with non-linear activation functions. The server configures the generative AI model with a specific number of layers, attention heads, hidden dimensions, and vocabulary size adapted to the sales dialog domain. The server uses token embeddings for subword units and positional encodings to provide order information.

The server uses the same framework to implement the success-probability prediction model as a feed-forward neural network or a gradient-boosted decision tree model. The server constructs feature vectors for this model by combining numerical features (for example, number of turns, discount amount, elapsed time), categorical features (for example, product type, scenario type), and derived features obtained from intermediate representations of the generative AI model (for example, the final hidden state of the last user utterance). The server normalizes continuous features and applies embedding layers to categorical features before feeding them into the prediction model.

The server executes a preprocessing module implemented with numerical libraries to transform raw sales activity results into a training data set. The server retrieves raw logs from the relational database via structured queries, loads the logs into memory as tabular structures, performs missing-value imputation, outlier removal, and normalization, and tokenizes dialog texts using a natural-language processing library. The server converts each dialog history into a sequence of token identifiers with associated speaker tags and emotion tags, and groups them into input-target pairs.

The server constructs training samples for the generative AI model by building prompt sentences and corresponding target texts. The server concatenates scenario descriptions, sales objectives, summarized previous turns, and encoded emotional states into a single prompt sentence. The server appends a separator token and the expected next utterance as target text. The server encodes emotional states as special tokens or as side vectors injected into the attention layers. Example prompt sentences used in training include:
“Scenario: selling a mid-range smartphone to a repeat customer. Objective: schedule a follow-up meeting. Conversation so far: [summary]. The user appears slightly confused. As the AI customer, generate the next response.”
“Scenario: offering an extended warranty. Objective: overcome price objection. Conversation so far: [summary]. The user appears skeptical. As the AI customer, generate a realistic skeptical response.”

The server trains the generative AI model by executing mini-batch gradient descent with backpropagation. The server computes a cross-entropy loss between the generated token probabilities and the target tokens, applies an optimizer such as Adam, and updates the model weights on the graphics processing unit. The server monitors validation loss and perplexity to prevent overfitting and stores checkpoints of the model parameters in non-volatile storage.

The server thus obtains a trained generative model that encodes statistical regularities of sales dialogs and emotional reactions.

The server trains the success-probability prediction model by constructing labeled samples from completed dialogs. The server aggregates features over each dialog, including the number of turns, the distribution of emotional states over time, the presence of specific objection patterns, and the last hidden states from the generative AI model for key utterances. The server uses a binary cross-entropy loss with respect to success/failure labels, and updates the prediction model parameters using gradient-based optimization. The server evaluates the model using accuracy, area under the ROC curve, and calibration metrics, and retains the best performing parameter set.

The server generates virtual customer information by defining attribute profiles and response styles. The server stores, for each virtual customer, attribute fields such as budget range, product preference, tolerance for risk, and typical emotional baseline. The server also stores numeric parameters that influence response style, including target politeness level, baseline skepticism weight, and preferred length of responses. The server uses these parameters to build control tokens and feature vectors that are injected into the generative AI model's input sequence or into its conditioning vectors.

The server receives configuration input from a user (for example, a trainer) through a web interface. The terminal, in this case, executes a web browser or a dedicated client application that displays a user interface generated by the server. The user selects a virtual customer profile and a scenario, and the server renders candidate response examples produced by the generative AI model under different conditions. The user edits text fields directly, inserting or replacing sentences such as changing “That sounds too expensive.” to “The features look good, but the price still worries me.” The terminal transmits the edited text and associated metadata (scenario identifier, emotion conditions, and user rating) back to the server.

The server stores the edited responses as overwrite rules and as additional supervised training samples. The server registers overwrite rules in a rule table specifying trigger conditions (for example, scenario type and emotion label) and replacement templates. During inference, the server checks whether an overwrite rule applies to a candidate response and, if applicable, replaces or modifies the candidate response accordingly. In addition, the server uses edited pairs as labeled examples for fine-tuning the generative AI model so that the model gradually approximates responses preferred by trainers.

The server performs inference by constructing prompt sentences during live interaction. The terminal acquires utterance information from the user via keyboard input or microphone input. When using audio, the terminal runs an automatic speech recognition component or transmits the audio data to a speech-to-text service, and then transmits the resulting text and session identifier to the server through a secure communication channel.

The server appends the user's new utterance to the dialog history in the database and passes the utterance text, along with associated audio or video features, to an emotion classifier. The server implements the emotion classifier as a neural network trained on acoustic and visual features, or it calls an external emotion-analysis service. The server receives a probability distribution over emotion categories and stores the highest-probability label and vector in the emotion table linked to the current turn.

The server constructs a prompt sentence for the generative AI model by summarizing the dialog up to the current turn. To maintain computational efficiency, the server uses an attention-based summarizer or a learned compression model to transform long histories into shorter context strings or vector summaries. The server includes in the prompt sentence: the scenario description, the virtual customer profile, a compressed conversation summary, the latest user utterance, the current emotional state, and the desired behavioral directive for the virtual customer. Example prompt sentences in inference include:
“Act as an AI customer in a smartphone-purchase scenario. The salesperson has just said: ‘This new model is very popular and has an excellent camera.’ The user appears slightly dissatisfied. As the AI customer, respond by acknowledging the concern about price and asking which features are most important.”
“Conversation so far: [summary]. The user currently appears skeptical. As the AI customer, generate three possible responses, each expressing a different level of resistance to the proposed warranty.”

The server forwards the constructed prompt sentence and control tokens to the generative AI model and obtains one or more candidate responses. The server applies decoding algorithms such as beam search or nucleus sampling with adjustable parameters for diversity and determinism. The server then passes each candidate response, along with the associated features (for example, predicted emotion, length, presence of key phrases), to the success-probability prediction model.

The server evaluates candidate responses by computing a success-probability score for each candidate. The server combines the success-probability scores with additional heuristic penalties or bonuses, such as penalties for excessive length or for violating politeness constraints, and optionally enforces consistency with an intended emotional trajectory. The server selects the candidate with the highest composite score and passes it to the overwrite-rule module. If a matching overwrite rule exists, the server modifies the response accordingly. The server then transmits the finalized AI-customer response to the terminal, which displays the response as text and optionally converts it to synthesized speech.

The server uses the same processing pipeline in a live support mode, where the terminal is a wearable device such as smart glasses. In this mode, the terminal captures speech from a real customer and sends transcribed text and optional audio features to the server. The server uses the generative AI model not only to produce virtual customer responses but also to generate sales support advice information for the user. The server constructs prompt sentences that instruct the generative AI model to output suggested actions rather than customer utterances, for example:
“Given the following dialog history and that the real customer appears interested in camera quality but concerned about price, generate a short suggestion for the salesperson about what to say next.”

The terminal displays the suggestion as overlay text in the user's field of view while the conversation continues. This configuration enables real-time, context-sensitive guidance that would not be feasible with static rule-based systems.

The server periodically performs batch retraining or fine-tuning. The server launches scheduled jobs that scan the database for new dialog sessions, new emotional-state records, edited responses, and new outcomes. The server merges these into an extended training data set and retrains the generative AI model and the success-probability prediction model. The server may perform incremental training using warm-started weights, applying learning-rate schedules, early stopping, and regularization techniques such as dropout and weight decay. By integrating newly collected data, the models adapt to shifting patterns of user behavior and product offerings.

The server improves computer technology in several ways. First, by jointly storing dialog histories, emotion vectors, model decisions, and human edits in a unified schema, the server reduces redundancy in training data management and enables efficient retrieval of relevant samples. This structured storage improves cache locality and reduces I/O overhead during both training and inference. Second, by embedding emotional states and summarized histories directly into prompt sentences and conditioning vectors for the generative AI model, the server reduces the need to maintain multiple specialized models for different emotional conditions, thereby decreasing memory usage and simplifying deployment.

Third, by using a success-probability prediction model to rank candidate responses, the server introduces a technical mechanism that balances language fluency with goal-oriented performance, resulting in reduced error rates for undesired behaviors (for example, suggesting inappropriate discounts) and improved stability of outcomes. This ranking pipeline transforms raw generative outputs into a filtered output stream optimized for a specific performance metric. Fourth, by converting trainer edits into overwrite rules and additional supervised signals, the server creates a feedback loop that steadily refines the response policies without requiring manual rewriting of static scripts. This approach leverages non-intuitive, high-dimensional representations within the generative AI model and uses them in ways that are not equivalent to simply automating human drafting.

The terminal, in multiple embodiments, may be implemented as a smartphone, a desktop computer, or a wearable display. The terminal is responsible for capturing user inputs, transmitting data to the server, and presenting generated outputs. The terminal may locally preprocess sensor data, such as downsampling video frames, extracting facial landmarks, or computing basic audio features, to reduce communication load before transmission. By performing partial feature extraction on the terminal, the system reduces bandwidth requirements and latency while preserving sufficient information for accurate emotion estimation and dialog analysis.

The user interacts with the system through these terminals. The user selects training scenarios, adjusts virtual customer profiles, and provides feedback on generated responses. The user may explicitly enter prompt sentences for advanced configuration, for example:
“As an AI customer, respond realistically to a salesperson who is introducing a new high-end model. Include at least one objection about budget and one question about battery life.”
“Generate a talk script that maximizes the probability of success when selling a mid-range smartphone to a customer who prioritizes cost performance and has previously purchased entry-level models.”

The server uses such user-supplied prompt sentences as additional conditions to guide the generative AI model and as labeled data for subsequent optimization.

Alternative embodiments may vary the internal architecture while preserving the core functions. In one variation, the server replaces the Transformer-based generative AI model with a recurrent neural network using gated recurrent units or long short-term memory cells, while maintaining the same prompt-construction and ranking pipeline. In another variation, the server uses a convolutional neural network for emotion estimation from facial images, combined with a separate acoustic model for emotion from audio. In yet another variation, the server implements the success-probability prediction model as an ensemble of decision trees instead of a neural network, using the same feature vectors.

The server, in each embodiment, maintains a modular structure including a data ingestion module, a preprocessing module, a training module, an inference engine, an emotion-analysis module, a ranking and rule-application module, and an interface module. By orchestrating these modules, the server executes a specific flow of data processing that improves the accuracy, speed, and robustness of generating context-appropriate, emotion-adaptive dialog responses and support information. The combination of generative AI model, success-probability prediction model, prompt sentence construction with embedded emotion and context, and continuous retraining with human edits provides a concrete technical solution that goes beyond simple automation of human drafting and results in measurable improvements in model performance and system throughput.

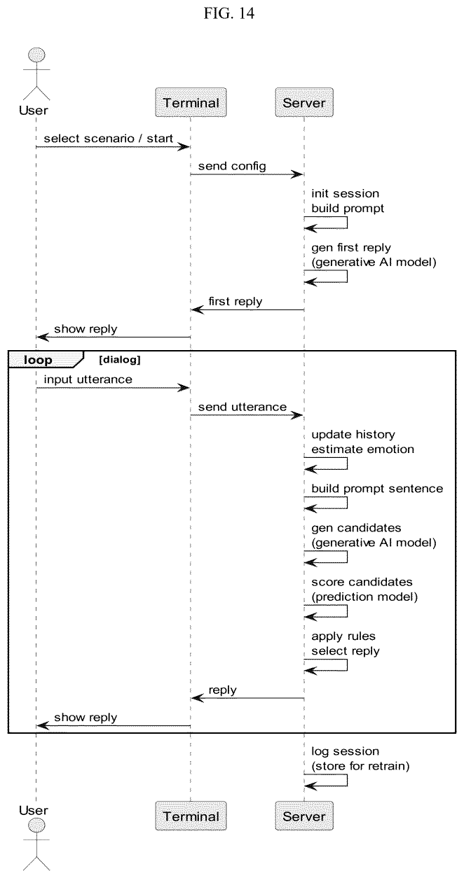

The following describes the processing flow using FIG. 14.

### Step 1:

The server acquires raw sales activity logs from a storage device.

The input is historical data including dialog transcripts, timestamps, product identifiers, and success/failure flags.

The server executes structured queries against a relational database to retrieve these records into memory, and the output is an in-memory table containing raw, unprocessed sales sessions.

### Step 2:

The server performs data cleaning and normalization.

The input is the in-memory table of raw sales sessions.

The server removes records with corrupted or empty mandatory fields, imputes missing numerical values with statistical aggregates, normalizes continuous features (such as discount rate or deal size) to a fixed range, encodes categorical fields (such as product category or scenario type) into numerical indices, and the output is a sanitized and normalized table of sales sessions.

### Step 3:

The server tokenizes and structures dialog histories.

The input is the sanitized table of sales sessions containing textual dialog fields.

The server applies a natural-language processing pipeline to segment each dialog into utterances, assigns speaker roles, tokenizes utterance text into subword units, and produces ordered sequences of token identifiers with corresponding turn indices; the output is a set of structured dialog histories ready for model training.

### Step 4:

The server attaches emotion labels to dialog turns.

The input is the set of structured dialog histories and any available audio or video features associated with each turn.

The server runs an emotion classification module that computes, for each turn, a probability distribution over emotion categories based on textual, acoustic, or visual features, selects the most likely category, and the output is an augmented dialog dataset where each turn includes an emotion label and associated confidence scores.

### Step 5:

The server constructs training samples for the generative AI model.

The input is the augmented dialog dataset with speaker roles, tokenized text, and emotion labels.

The server builds, for each training sample, a prompt sentence that concatenates scenario description, sales objective, summarized prior turns, and encoded emotional state, and appends the expected next utterance as a target sequence; the output is a collection of (prompt sentence, target utterance) pairs.

### Step 6:

The server trains the generative AI model on the constructed samples.

The input is the collection of (prompt sentence, target utterance) pairs.

The server converts each prompt sentence and target into token indices, feeds mini-batches into a Transformer-based neural network, computes cross-entropy loss between predicted token distributions and target tokens, performs backpropagation and parameter updates using an optimizer, and the output is a trained generative AI model with learned weight parameters stored in persistent storage.

### Step 7:

The server builds feature vectors for success-probability prediction.

The input is the augmented dialog dataset with outcome labels and the trained generative AI model.

The server aggregates per-dialog features such as number of turns, distribution of emotion labels, occurrence of key patterns, and obtains intermediate hidden states from the generative AI model for selected utterances; the server concatenates these values into fixed-length feature vectors, and the output is a labeled feature matrix paired with success/failure indicators.

### Step 8:

The server trains the success-probability prediction model.

The input is the labeled feature matrix and success/failure indicators.

The server splits the data into training and validation sets, feeds feature vectors into a predictive model (for example, a neural network or tree ensemble), computes a loss function such as binary cross-entropy, updates model parameters through gradient-based optimization or boosting iterations, evaluates accuracy and calibration, and the output is a trained success-probability prediction model with stored parameters.

### Step 9:

The server generates and stores virtual customer profiles.

The input is the learned statistics from sales data and configuration parameters provided by an administrator.

The server defines, for each profile, attributes such as budget range, product preferences, risk tolerance, and default emotional style, encodes these attributes as numerical control vectors or special tokens, and stores them in a profile table; the output is a set of machine-readable virtual customer profiles.

### Step 10:

The user configures a training scenario through the terminal.

The input is user interaction on a graphical user interface where the user selects a scenario type, a virtual customer profile, and optional difficulty parameters.

The terminal packages the selections into a configuration message, transmits the message to the server, and the output is a scenario configuration received and stored by the server for the upcoming session.

### Step 11:

The server initializes a dialog session and generates an initial AI-customer utterance.

The input is the scenario configuration and a selected virtual customer profile.

The server constructs an initial prompt sentence describing the scenario, objectives, and virtual customer attributes, inputs the prompt sentence into the trained generative AI model, decodes the output sequence into natural-language text, and the output is the initial AI-customer utterance associated with a new session identifier.

### Step 12:

The terminal presents the AI-customer utterance to the user.

The input is the initial AI-customer utterance and session identifier received from the server.

The terminal displays the utterance as text in a chat interface or overlay, optionally converts it into synthesized speech using a text-to-speech component, and the output is a visual and/or auditory presentation of the AI-customer utterance to the user.

### Step 13:

The user inputs a response via the terminal.

The input is the displayed AI-customer utterance and the user's interaction with input devices (keyboard, touchscreen, or microphone).

The user types or speaks a response; the terminal captures the text or records audio and, if audio is used, applies or invokes speech-to-text conversion, and the output is a user utterance encoded as text with associated session identifier and timestamp.

### Step 14:

The terminal transmits the user utterance and optional sensor features to the server.

The input is the user utterance text and any locally computed features such as basic audio statistics or facial landmark positions.

The terminal packages the data into a request message, sends it over a network connection to the server, and the output is a structured request received by the server containing the latest user input and context identifiers.

### Step 15:

The server updates the dialog history and estimates the current emotional state.

The input is the structured request containing the user utterance and optional features.

The server appends a new turn record to the dialog history in the database, passes the utterance text and features to an emotion classifier, computes a probability distribution over emotion categories, selects the predominant category, and the output is an updated dialog history with an added turn linked to an emotion label.

### Step 16:

The server constructs a context-rich prompt sentence for the next AI-customer response.

The input is the updated dialog history, the latest emotional state, and the virtual customer profile for the session.

The server summarizes previous turns to respect context length constraints, concatenates the scenario description, summarized history, latest user utterance, emotion label, and virtual customer control tokens into a single prompt sentence, and the output is a context-rich prompt sentence representing the current interaction state.

### Step 17:

The server invokes the generative AI model to produce candidate responses.

The input is the context-rich prompt sentence and virtual customer control tokens.

The server encodes the prompt into token indices, feeds the indices into the trained generative AI model, applies a decoding strategy such as beam search to generate multiple candidate sequences, decodes the sequences into natural-language strings, and the output is a set of candidate AI-customer responses.

### Step 18:

The server evaluates candidate responses using the success-probability prediction model.

The input is the set of candidate responses, the current context features, and the trained success-probability prediction model.

The server constructs a feature vector for each candidate by combining dialog context features, emotion state, and response-specific features (such as length and presence of key phrases), feeds each vector into the prediction model, obtains a numerical success-probability score for each candidate, and the output is a list of candidate responses paired with scores.

### Step 19:

The server applies overwrite rules and selects a final AI-customer response.

The input is the scored candidate responses and a rule set derived from trainer edits.

The server scans for applicable overwrite rules based on scenario type and emotion label, modifies or replaces candidate responses where rules apply, adjusts scores if necessary, selects the candidate with the highest adjusted score, and the output is a finalized AI-customer response text to be returned to the terminal.

### Step 20:

The terminal presents the finalized AI-customer response to the user.

The input is the finalized AI-customer response and session identifier from the server.

The terminal updates the chat interface or overlay with the new utterance, optionally triggers text-to-speech synthesis, and the output is an updated dialog view that the user can read or hear before entering the next response.

### Step 21:

The server logs interaction data for retraining.

The input is the complete turn information including user utterances, AI-customer responses, emotion labels, success-probability scores, selected candidate flags, and any user ratings.

The server writes these data as records into dedicated log tables, ensuring that each record links to session identifiers and outcome fields; the output is a persistent interaction log that can be retrieved as retraining data.

### Step 22:

The user optionally edits AI-customer responses through a trainer interface.

The input is the displayed AI-customer responses and configuration controls presented on the terminal.

The user modifies response text or marks certain responses as preferred or inappropriate; the terminal sends the edited text and annotation flags to the server, and the output is a set of trainer edits and labels received by the server.

### Step 23:

The server converts trainer edits into overwrite rules and training samples.

The input is the trainer edits and associated context information.

The server extracts trigger conditions from context (such as scenario identifier and emotion state), stores mapping rules that specify how generated text should be replaced or adjusted, and also constructs new (prompt sentence, target response) pairs for fine-tuning; the output is an updated rule set and an extended training sample pool.

### Step 24:

The server performs periodic retraining or fine-tuning of models.

The input is the extended training sample pool and the interaction logs accumulated since the last training cycle.

The server reinitializes or warm-starts the generative AI model and the success-probability prediction model, runs additional training epochs on the new data while monitoring validation metrics, updates the stored model parameters when performance improves, and the output is refreshed models that better reflect recent interactions and trainer preferences.

### Step 25:

The server generates real-time sales support advice in live customer interactions.

The input is real customer utterances and emotional states captured by the terminal and transmitted to the server during a live session.

The server constructs prompt sentences that instruct the generative AI model to output suggestions for the salesperson, generates one or more advice texts, optionally ranks them using the success-probability prediction model, and the output is a selected advice text transmitted to the terminal for display as an overlay.

### Step 26:

The terminal reduces communication load by local preprocessing of sensor data.

The input is raw audio or video streams captured by the terminal during interactions.

The terminal computes compact features such as downsampled spectrograms or facial landmark coordinates, discards redundant frames, and transmits only the derived features to the server, and the output is a reduced-size feature stream that lowers network bandwidth usage while preserving key information for emotion and dialog analysis.

### Step 27:

The server updates virtual customer profiles based on aggregated performance statistics.

The input is long-term logs of session outcomes and response effectiveness associated with each virtual customer profile.

The server analyzes these logs to detect patterns where certain attribute settings or response styles lead to better success probabilities, adjusts numeric style parameters such as skepticism or politeness levels accordingly, and the output is a revised set of virtual customer profiles that guide future prompt construction and response generation.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

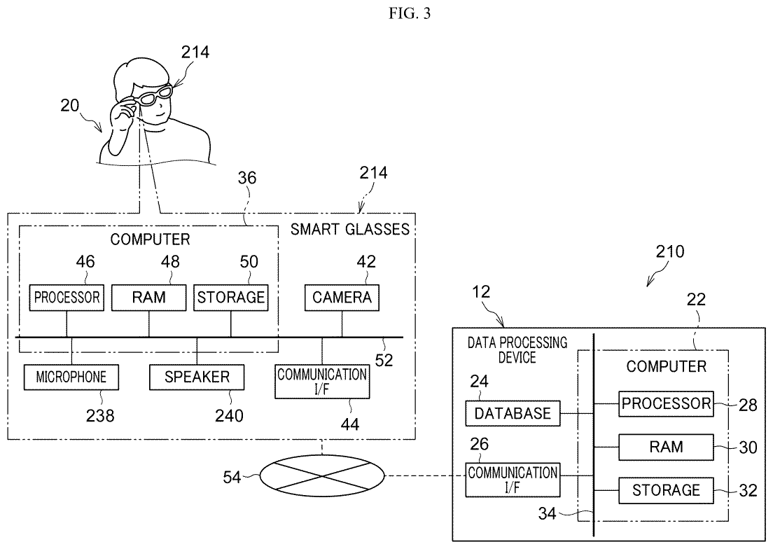

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

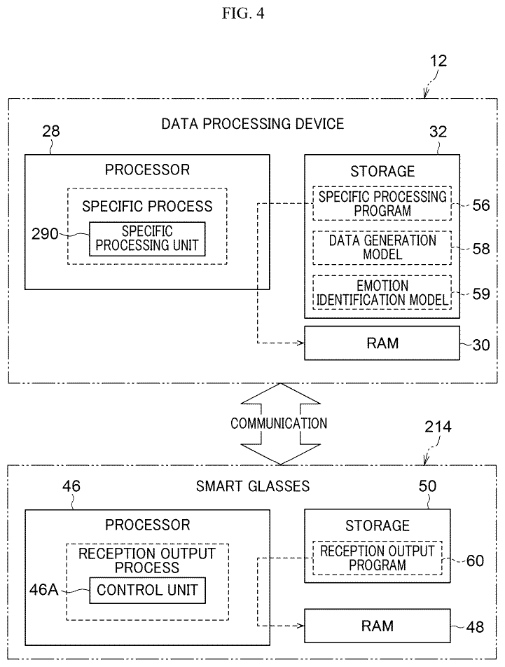

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

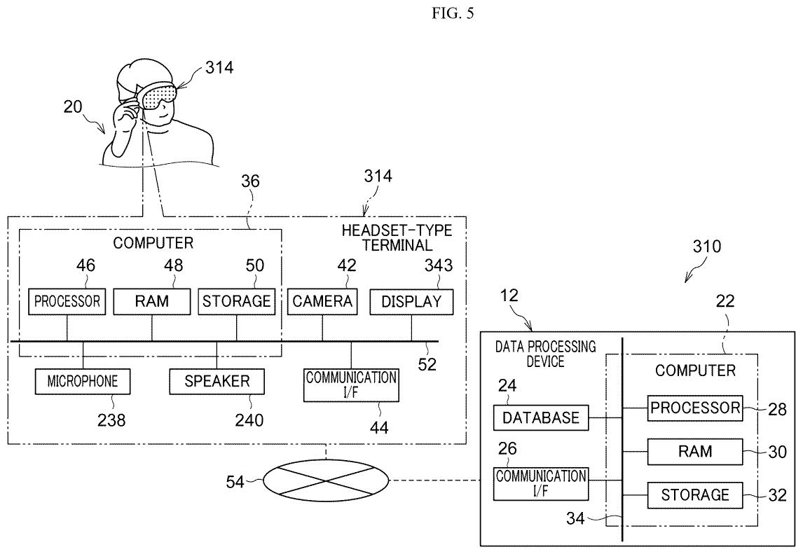

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

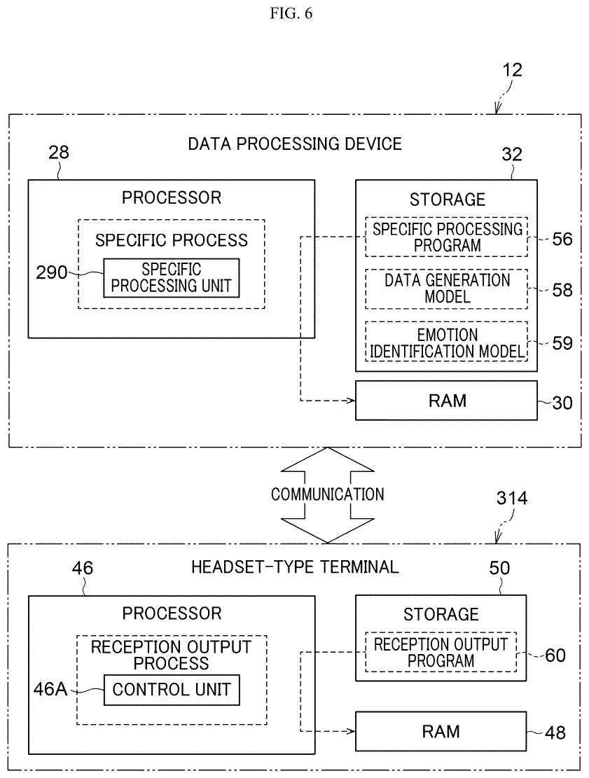

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

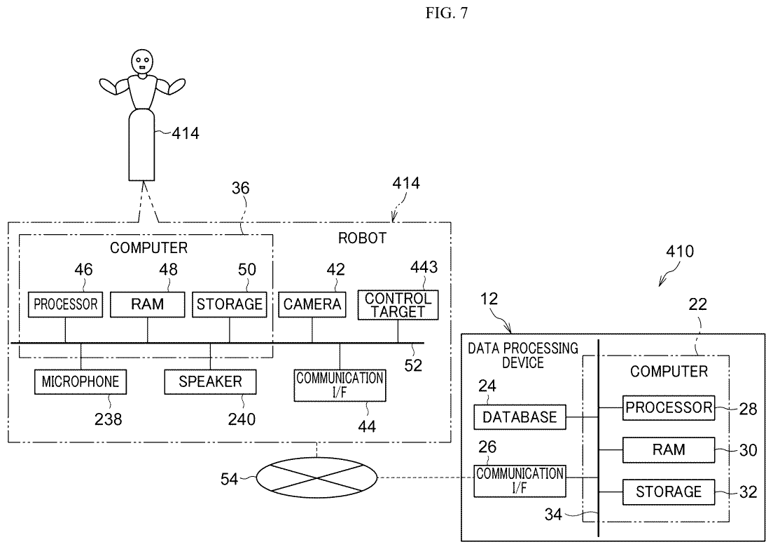

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

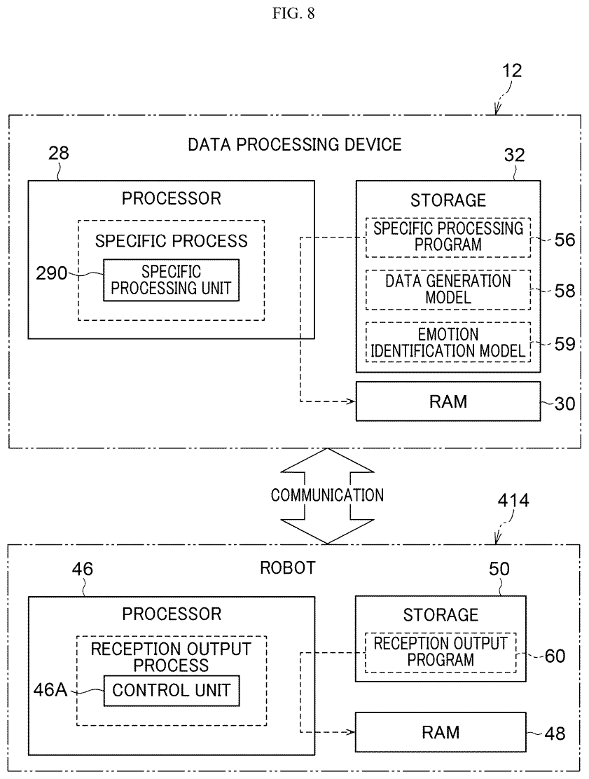

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

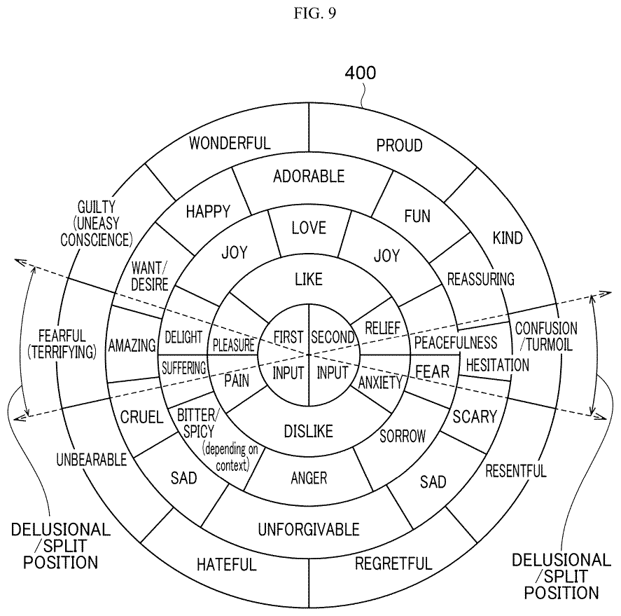

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

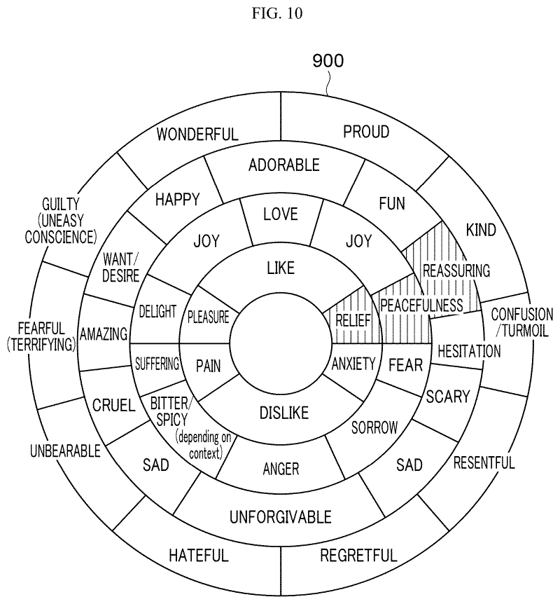

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, from an information storage device, a plurality of pieces of historical information relating to business activities, and extract a plurality of types of information including customer attribute information, sales method information, and outcome information from the historical information,
perform preprocessing on the extracted historical information by executing, using a general information processing program, at least completion of missing information, removal of abnormal information, and encoding of classification information, and generate numerical feature information suitable for machine learning processing,
construct and train a prediction machine learning model on the basis of the generated numerical feature information and the outcome information, and store the prediction machine learning model as a trained prediction model that is configured to output prediction information indicating success or failure of a business activity,
extract, on the basis of an output result of the trained prediction model and the historical information, sales patterns and customer segments having a relatively high probability of success, and generate a prompt sentence including virtual customer conditions and dialogue structure in accordance with an extraction result,
input the generated prompt sentence as input information to a generative artificial intelligence model, and cause the generative artificial intelligence model to generate artificial intelligence customer scenario information including persona information of a virtual customer, initial utterance information, objection information, and a plurality of response path information items,
generate a dialogue simulation environment by using the artificial intelligence customer scenario information, transmit utterance information of an artificial intelligence customer to a user information processing terminal in response to access from the user information processing terminal, and receive response information from a user,
record the response information of the user and the utterance information of the artificial intelligence customer as dialogue history information, sequentially extract utterance feature quantities from the dialogue history information, evaluate the response information of the user by using the trained prediction model, and generate feedback information including at least evaluation indices of objection handling degree, value presentation degree, and presence or absence of closing behavior,
transmit the generated feedback information to the user information processing terminal in real time or at an end of a session and present, to the user, improvement points of a sales method and recommended utterance examples, and
accumulate the dialogue history information and the evaluation indices as additional learning data, and retrain or fine-tune at least one of the prediction machine learning model and the generative artificial intelligence model so as to continuously improve generation accuracy of the artificial intelligence customer scenario information and evaluation accuracy of the business activities.

### (Supplementary 2)

The system according to supplementary 1,
wherein the processor is configured to
receive audio information transmitted from the user information processing terminal, convert the audio information into character information by audio recognition processing, and supply the character information as the dialogue history information to the prediction machine learning model and the generative artificial intelligence model so as to enable a business activity simulation through audio input.

### (Supplementary 3)

The system according to supplementary 1,
wherein the processor is configured to
generate the prompt sentence to be provided to the generative artificial intelligence model on the basis of skill level information of the user, past dialogue history information, and selected training objective information, and dynamically adjust at least a reaction pattern of the artificial intelligence customer, difficulty information, and objection frequency so as to generate artificial intelligence customer scenario information adapted to each user.

### Application Example 1

### (Supplementary 1)

A system comprising a processor, a storage device, a terminal device, and a generative artificial intelligence model,
wherein the processor is configured to acquire, from the storage device, historical information relating to a plurality of sales activities, extract feature information from the historical information using, as an objective variable, identification information indicating success or failure of each sales activity, normalize the feature information, and execute statistical learning processing on the normalized feature information so as to generate a prediction model configured to estimate a probability of success of a sales activity,
wherein the processor is configured to extract, from the prediction model, feature information that contributes to success, and automatically generate a prompt sentence including conditions of a sales situation, a customer attribute, and a dialog difficulty level based on the feature information, and to supply the prompt sentence as input information to the generative artificial intelligence model so as to generate scenario information including a dialog scenario of a virtual customer and a response pattern of the virtual customer,
wherein the processor is configured to structure the scenario information into a machine-readable format, to assign, to each dialog turn, utterance information of the virtual customer, assumed user-intent information, and branch transition information, to store the structured information as scenario management information in the storage device, and to transmit the scenario management information to the terminal device in response to a request from the terminal device,
wherein the processor is configured to transmit the scenario management information to the terminal device including a wearable display apparatus having a display function and an audio input/output function, to cause the terminal device to present the utterance information of the virtual customer to a user as visual information and auditory information, and to receive, from the terminal device, response information including audio information and motion information acquired from the user,
wherein the processor is configured to convert the audio information included in the response information into language information, to perform natural language processing on the language information to extract phrase information, emotion information, and persuasiveness evaluation information, and to generate evaluation information including at least clarity, persuasiveness, and a degree of matching to a success pattern by comparing the extracted result with the prediction model and recommended talk-script information,
wherein the processor is configured to generate an evaluation prompt sentence including the evaluation information and most recent utterance information of the virtual customer, to supply the evaluation prompt sentence as input information to the generative artificial intelligence model, to generate feedback information including specific improvement points and alternative expression examples for a user utterance, and to transmit the feedback information to the terminal device,
wherein the processor is configured to determine next utterance information of the virtual customer by referring to the branch transition information of the scenario management information based on the response information and the evaluation information, or by supplying a next-step prompt sentence to the generative artificial intelligence model, and to transmit the next utterance information to the terminal device, and
wherein the processor is configured to store the historical information, the response information, the evaluation information, and the feedback information as learning-record information in the storage device, and to periodically execute retraining of the prediction model and updating of a prompt-sentence generation rule for the generative artificial intelligence model based on the learning-record information.

### (Supplementary 2)

The system according to supplementary 1,
wherein the processor is configured to control the terminal device so that the terminal device displays the utterance information of the virtual customer in a main display area of the wearable display apparatus and simultaneously displays the feedback information in a sub-display area, and, in response to an operation input or a motion input by the user, performs scroll display or display switching of the feedback information so as to present improvement points in real time without interrupting progress of dialog.

### (Supplementary 3)

The system according to supplementary 1,
wherein the processor is configured to associate dialog results in a virtual environment included in the learning-record information with sales results in a real environment, to generate integrated learning data, and to use the integrated learning data to update both the prediction model and the generative artificial intelligence model, thereby dynamically adjusting behavioral characteristics of the virtual customer and contents of the feedback information to approximate the sales results in the real environment.

### Example 2

### (Supplementary 1)

A system comprising a processor,
wherein the processor is configured to
collect, as time-series information, dialogue information including success and failure experiences related to sales activities, and store the dialogue information as recording information in a storage,
extract, as character information, a prompt sentence from a user and a response sentence from an artificial-intelligence customer included in the recording information, and convert the character information into preprocessed data in a format suitable for training data by removing unnecessary symbols and performing normalization processing and segmentation processing,
retrain a generative AI model by using the preprocessed data as input information with a machine-learning program, and update configuration information of the generative AI model, deploy the updated generative AI model and corresponding encoding information to an inference execution environment, and provide the generative AI model so as to be available in response to an access request from an external apparatus,
acquire a prompt sentence input by the user via an external terminal apparatus, input the prompt sentence to the generative AI model to generate a response sentence as the artificial-intelligence customer, and transmit the response sentence to the external terminal apparatus, append the prompt sentence and the response sentence as a dialogue history to the recording information, and accumulate the dialogue history as training data used for preprocessing and retraining in a subsequent cycle,
construct a training data set by performing weighting or selection, based on evaluation information included in the recording information, on high-rated dialogue information among the preprocessed data, and
update a reaction pattern of the artificial-intelligence customer in the generative AI model according to the training data set and attribute information of the prompt sentence from the user, and form dynamic response generation behavior reflecting trends of the sales activities.

### (Supplementary 2)

The system according to supplementary 1,
wherein the processor is configured to
manage an identification information of the generative AI model used in the inference execution environment in association with the dialogue history and the evaluation information, compare response tendencies of the generative AI model before and after updating for each identification information to determine a reflection degree of success and failure experiences in the sales activities, and control at least one of a retraining frequency and a configuration of the training data set based on a determination result.

### (Supplementary 3)

The system according to supplementary 1,
wherein the processor is configured to
estimate attribute information of an assumed customer and state information of a dialogue situation based on contents of the prompt sentence input by the user from the external terminal apparatus, change selection or weighting of the reaction pattern in the generative AI model according to the attribute information and the state information, and dynamically adjust the response sentence of the artificial-intelligence customer in a simulation format of the sales activities.

### Application Example 2

### (Supplementary 1)

A system comprising a processor,
wherein the processor is configured to
acquire a set of sales activity results as training data, and perform learning using a generative AI model on the basis of dialog histories and success/failure information included in the training data; and
generate virtual customer information including attribute information of a virtual dialog entity and a response style on the basis of a result of the learning, and generate a virtual dialog response corresponding to the virtual customer information by inputting a prompt sentence including a dialog situation and a sales objective into the generative AI model; and estimate an emotional state on the basis of utterance information and behavior information of a user acquired from a user terminal, and dynamically construct the prompt sentence by including the emotional state and the dialog history and input the prompt sentence into the generative AI model so as to generate the virtual dialog response in an emotion-adaptive manner based on the virtual customer information; and
record, in association with one another, dialog contents of the user, the virtual dialog response, the emotional state, and a sales result generated in a course of a sales action for the virtual customer information, and accumulate a recording result as retraining data for the generative AI model and a success-probability prediction model; and
periodically update the generative AI model and the success-probability prediction model on the basis of the accumulated retraining data, and automatically adjust the response style of the virtual customer information and a sales dialog script on the basis of the updated models; and present candidate responses of the virtual customer information and generation conditions thereof on a display device, acquire edit contents from the user, store the edit contents as an overwrite rule for the response style, and reflect the edit contents as additional training data in the generative AI model; and
extract recommendation targets on the basis of real customer information and past transaction history acquired during a dialog with a real customer, input a prompt sentence including the recommendation targets and the dialog history into the generative AI model to generate an explanatory text for a proposal, and present the explanatory text for the proposal to the user terminal.

### (Supplementary 2)

The system according to supplementary 1,
wherein the processor is configured to
evaluate a plurality of virtual dialog response candidates obtained from the generative AI model, on the basis of a success probability calculated by the success-probability prediction model and the emotional state, and select a virtual dialog response candidate determined to have a high success probability and to be compatible with the emotional state, and present the selected virtual dialog response candidate to the user terminal.

### (Supplementary 3)

The system according to supplementary 1,
wherein the processor is configured to
construct the prompt sentence to be input to the generative AI model on the basis of utterance information, behavior information, and the emotional state of the real customer acquired during a dialog with the real customer, obtain sales support advice information from the prompt sentence via the generative AI model, and present the sales support advice information to a visual display device as an overlapping display so as to present a customer-service action to the user in real time.

What is claimed is:

1. A system comprising:
circuitry configured to:
receive, via a communication interface coupled to a packet-switched network, historical interaction data from an information storage device, and perform data preprocessing comprising completion of missing values, removal of abnormal values, and encoding of categorical values to generate numerical feature information;
construct and train a prediction machine learning model on the basis of the numerical feature information and outcome information to obtain a trained prediction model, and extract activity patterns and subject segments having a relatively high success probability using output results of the trained prediction model and the historical interaction data;
generate structured prompt sentences comprising virtual subject conditions and dialog structures based on the extracted activity patterns and subject segments, and provide the structured prompt sentences as input to a generative AI model to generate AI agent scenario information comprising virtual subject persona information and initial dialog states;
provide an interactive session in which a user interacts with the AI agent via the communication interface, receive prompt inputs from the user for instructing execution of a dialog activity, and collect feedback data comprising interaction outcomes and user performance metrics from the interactive session; and
feed back the collected feedback data as training data to update the trained prediction model and the generative AI model, and store updated model parameters in the information storage device.

2. The system according to claim 1, wherein the circuitry is configured to receive utterance information and behavioral information from a terminal device during a live interaction session, apply an emotion recognition model to the utterance information to generate an emotional state representation of an interacting subject, and generate a prompt sentence incorporating the emotional state representation for input to the generative AI model to obtain real-time advisory content.

3. The system according to claim 2, wherein the circuitry is configured to transmit the real-time advisory content to a visual display device as an overlay display, presenting recommended interaction actions to the user based on the emotional state representation of the interacting subject.

4. The system according to claim 3, wherein the circuitry is configured to update the overlay display at predetermined intervals based on continuously updated emotional state representations derived from ongoing utterance information received from the terminal device.

5. The system according to claim 4, wherein the circuitry is configured to accumulate real-time advisory content and corresponding interaction outcomes in the information storage device, and apply a reinforcement learning model to the accumulated data to improve the quality of subsequent real-time advisory content generation.

6. The system according to claim 1, wherein the circuitry is configured to dynamically adjust a reaction pattern of the AI agent based on a learning result of the generative AI model in response to prompt inputs from the user, to enable the AI agent to generate contextually appropriate dialog responses.

7. The system according to claim 6, wherein the circuitry is configured to apply a dialog state tracking model to the sequence of user prompt inputs and AI agent responses to maintain a dialog state representation, and incorporate the dialog state representation in the generative AI model input to ensure coherent multi-turn interactions.

8. The system according to claim 1, wherein the circuitry is configured to apply a clustering algorithm to the extracted subject segments to generate segment profiles, and use the segment profiles to parameterize virtual subject persona information in the AI agent scenario information.

9. The system according to claim 8, wherein the circuitry is configured to apply a pattern diversity analysis to the extracted activity patterns to ensure that generated AI agent scenario information covers a representative range of interaction scenarios, and generate additional scenario variants when diversity falls below a predetermined threshold.

10. The system according to claim 1, wherein the circuitry is configured to apply a performance evaluation model to the user performance metrics collected from the interactive session to generate a skill assessment score for each predefined competency category, and transmit the skill assessment scores to the terminal device.

11. The system according to claim 10, wherein the circuitry is configured to generate personalized training recommendation content by supplying a prompt sentence incorporating the skill assessment scores to the generative AI model, and transmit the training recommendation content to the terminal device.

12. The system according to claim 1, wherein the circuitry is configured to apply a data normalization function to the numerical feature information to ensure consistent scale across heterogeneous feature types, and apply a feature selection model to identify the most predictive features for inclusion in the trained prediction model.

13. The system according to claim 12, wherein the circuitry is configured to apply cross-validation processing to the trained prediction model to evaluate prediction accuracy, and retrain the model with updated hyperparameters when the cross-validation accuracy falls below a predetermined threshold.

14. The system according to claim 1, wherein the circuitry is configured to generate scenario difficulty variants by modifying virtual subject conditions in the structured prompt sentences, and present increasingly difficult scenario variants to the user as interaction proficiency metrics improve.

15. The system according to claim 14, wherein the circuitry is configured to apply an adaptive difficulty adjustment model to the user performance metrics to select a scenario difficulty level for each subsequent interactive session, and generate prompt sentences corresponding to the selected difficulty level.

16. The system according to claim 1, wherein the circuitry is configured to apply a knowledge extraction model to accumulated historical interaction data to identify recurring patterns in successful interaction sequences, and generate updated structured prompt sentences incorporating the identified patterns.

17. The system according to claim 16, wherein the circuitry is configured to apply a novelty detection model to the updated structured prompt sentences to identify patterns that differ substantially from prior training scenarios, and prioritize novel patterns for inclusion in AI agent scenario generation.

18. A system comprising:
circuitry configured to:
receive, via a communication interface coupled to a packet-switched network, historical interaction data, perform data preprocessing to generate numerical feature information, train a prediction machine learning model on the numerical feature information and outcome information, and extract activity patterns and subject segments with high success probability;
generate structured prompt sentences incorporating virtual subject conditions and dialog structures from the extracted patterns, input the prompt sentences to a generative AI model to generate AI agent scenario information, and provide interactive sessions in which a user interacts with the AI agent;
receive utterance information and behavioral information during live interaction sessions, apply an emotion recognition model to generate an emotional state representation, generate real-time advisory content incorporating the emotional state representation, and transmit the advisory content as an overlay display to a terminal device;
collect feedback data from interactive sessions and feed back the feedback data as training data to update the prediction machine learning model and the generative AI model; and
apply a performance evaluation model to user performance metrics to generate skill assessment scores, and generate personalized training recommendation content by supplying the scores to the generative AI model.

19. The system according to claim 18, wherein the circuitry is configured to apply a reinforcement learning model to accumulated real-time advisory content and interaction outcomes to improve advisory content quality, apply a dialog state tracking model to maintain dialog state representations for multi-turn interactions, and update AI agent reaction patterns based on generative AI model learning results.

20. A method comprising:
receiving, via a communication interface coupled to a packet-switched network, historical interaction data from an information storage device, and performing data preprocessing comprising completion of missing values, removal of abnormal values, and encoding of categorical values to generate numerical feature information;
constructing and training a prediction machine learning model on the basis of the numerical feature information and outcome information to obtain a trained prediction model, and extracting activity patterns and subject segments having a relatively high success probability using output results of the trained prediction model;
generating structured prompt sentences comprising virtual subject conditions and dialog structures based on the extracted activity patterns and subject segments, and providing the structured prompt sentences as input to a generative AI model to generate AI agent scenario information;
providing an interactive session in which a user interacts with the AI agent via the communication interface, receiving prompt inputs from the user, and collecting feedback data comprising interaction outcomes and user performance metrics; and
feeding back the collected feedback data as training data to update the trained prediction model and the generative AI model, and storing updated model parameters in the information storage device.
